(19) United States
(12) Patent Application Publication
(10) Pub. No.: US 2015/0092637 A1
(43) Pub. Date: Apr. 2, 2015

(54) SIGNAL TRANSCEIVING METHOD AND APPARATUS FOR SAME

(71) Applicant: LG ELECTRONICS INC., Seoul (KR)

(72) Inventors: Suckchel Yang, Anyang-si (KR); Joonkui Ahn, Anyang-si (KR)

(73) Assignee: LG ELECTRONICS INC., Seoul (KR)

(21) Appl. No.: 14/396,313

(22) PCT Filed: May 27, 2013
(86) PCT No.: PCT/KR2013/004613

§ 371 Date: Oct. 22, 2014

Related U.S. Application Data
(60) Provisional application No. 61/651,563, filed on May 25, 2012.

(51) Int. Cl. H04L 5/16; H04L 1/16

(52) U.S. Cl. CPC H04L 5/16; H04L 1/1607
USPC 370/296

(57) ABSTRACT

The present invention relates to a wireless communication system. More particularly, the present invention relates to a method and apparatus for transceiving a signal in a half-duplex manner in a wireless communication system in which a first carrier and a second carrier are aggregated. The method comprises: a step of receiving a downlink signal on a first carrier during a first symbol period of a specific subframe; and a step of transmitting an uplink signal on a second carrier during a second symbol period of the specific subframe. The specific subframe is set as a downlink subframe in the first carrier and as an uplink subframe in the second carrier. The specific subframe is set to transmit an uplink reference signal.

### TECHNICAL FIELD

The present invention relates to a wireless communication system, and more particularly, to a method of efficiently transceiving a signal in a wireless communication system and an apparatus therefor.

### BACKGROUND ART

Recently, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may include one of CDMA (code division multiple access) system, FDMA (frequency division multiple access) system, TDMA (time division multiple access) system, OFDMA (orthogonal frequency division multiple access) system, SC-FDMA (single carrier frequency division multiple access) system, MC-FDMA (multi carrier frequency division multiple access) system and the like. In a wireless communication system, a user equipment receives information from a base station in downlink (hereinafter abbreviated DL) and the user equipment can transmit information to the base station in uplink (hereinafter abbreviated UL). The information transmitted or received by the user equipment includes data and various control information. There exist various physical channels according to a type and a usage of the information transmitted or received by the user equipment.

### DISCLOSURE OF THE INVENTION

### Technical Tasks

One object of the present invention is to provide a method of efficiently transceiving a signal in a wireless communication system and an apparatus therefor.

If UL signal transmission and DL signal reception are collided with each other on a specific timing, another object of the present invention is to provide a method of efficiently transceiving an UL signal and a DL signal and an apparatus therefor.

Technical tasks obtainable from the present invention are non-limited the above-mentioned technical task. And, other unmentioned technical tasks can be clearly understood from the following description by those having ordinary skill in the technical field to which the present invention pertains.

### Technical Solution

In an aspect of the present invention, disclosed herein is a method of transceiving a signal in a specific subframe by a user equipment operating in a half duplex scheme in a wireless communication system in which a first carrier and a second carrier are aggregated, the method comprising receiving a downlink signal on the first carrier during a first symbol period of the specific subframe; and transmitting an uplink signal on the second carrier during a second symbol period of the specific subframe, wherein the specific subframe may be configured as a downlink subframe on the first carrier and the specific subframe may be configured as an uplink subframe on the second carrier, and wherein the specific subframe may correspond to a subframe configured to transmit an uplink reference signal.

Preferably, the specific subframe may further corresponds to a subframe configured to receive an ACK/NACK (acknowledgement/negative-acknowledgement) signal in response to uplink data transmission.

Preferably, the method may further include receiving information indicating that an aperiodic sounding reference signal is to be transmitted in the specific subframe, wherein the uplink reference signal may include the aperiodic sounding reference signal.

Preferably, the method may further include receiving information indicating that a random access preamble signal is to be transmitted in the specific subframe, wherein the uplink signal may include the random access preamble signal.

Preferably, the specific subframe may comprise a downlink period, a guard period and an uplink period on the first carrier, and the first symbol period may include at least a part of the downlink period.

Preferably, the specific subframe may comprise a downlink period, a guard period and an uplink period on the second carrier, and the second symbol period can include at least a part of the uplink period.

Preferably, when the user equipment satisfies a certain condition, the method may further include receiving information indicating that the specific subframe is to be reconfigured from an uplink subframe to a downlink subframe on the second carrier; and receiving the downlink signal on the second carrier during the first symbol period of the specific subframe.

Preferably, the first symbol period may include 3 to 12 symbols, and the second symbol period may include 1 to 2 symbols.

In another aspect of the present invention, disclosed herein is a user equipment configured to transceive a signal in a specific subframe using a half-duplex scheme in a wireless communication system in which a first carrier and a second carrier are aggregated, the user equipment comprising an RF (radio frequency) unit; and a processor, the processor configured to receive a downlink signal on the first carrier during a first symbol period of the specific subframe, and transmit an uplink signal on the second carrier during a second symbol period of the specific subframe, wherein the specific subframe may be configured as a downlink subframe on the first carrier and the specific subframe may be configured as an uplink subframe on the second carrier, and the specific subframe may correspond to a subframe configured to transmit an uplink reference signal.

Preferably, the specific subframe may further correspond to a subframe configured to receive an ACK/NACK (acknowledgement/negative-acknowledgement) signal in response to uplink data transmission.

Preferably, the processor may be further configured to receive information indicating that an aperiodic sounding reference signal is to be transmitted in the specific subframe, and the uplink reference signal may include the aperiodic sounding reference signal.

Preferably, the processor may be further configured to receive information indicating that a random access preamble signal is to be transmitted in the specific subframe, and the uplink signal may include the random access preamble signal.

Preferably, the specific subframe may include a downlink period, a guard period and an uplink period on the first carrier, and the first symbol period may include at least a part of the downlink period.

Preferably, the specific subframe may include a downlink period, a guard period and an uplink period on the second carrier, and the second symbol period may include at least a part of the uplink period.

Preferably, when the user equipment satisfies a certain condition, the processor may be further configured to receive information indicating that the specific subframe is to be reconfigured from an uplink subframe to a downlink subframe on the second carrier, and receive the downlink signal on the second carrier during the first symbol period of the specific subframe.

Preferably, the first symbol period may include 3 to 12 symbols and the second symbol period may include 1 to 2 symbols.

### Advantageous Effects

According to the present invention, it is able to efficiently transceive a signal in a wireless communication system.

According to the present invention, when UL signal transmission and DL signal reception are collided with each other on a specific timing, it is able to efficiently transceive a UL signal and a DL signal.

Effects obtainable from the present invention may be non-limited by the above mentioned effects. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram for explaining physical channels used for LTE (-A) system and a method of transmitting a signal using the same;

FIG. 2 is a diagram for a structure of a radio frame in LTE (-A) system;

FIG. 3 is a diagram for one example of a resource grid for a downlink slot in LTE (-A) system;

FIG. 4 is a diagram for a structure of a downlink subframe in LTE (-A) system;

FIG. 5 is a diagram for a control channel assigned to a downlink subframe;

FIG. 6 is a diagram for a structure of an uplink subframe in LTE (-A) system;

FIGS. 7 and 8 are diagrams for examples of PHICH/UL grant-PUSCH timing;

FIGS. 9 and 10 are diagrams for PUSCH-PHICH/UL grant timing;

FIG. 11 is a diagram for an example of a reference signal used for an uplink subframe in LTE system;

FIG. 12 is a diagram for an example of a carrier aggregation (CA) communication system;

FIG. 13 is a diagram for an example of scheduling in case that a plurality of carriers are aggregated;

FIG. 14 is a diagram for an example of assigning a downlink physical channel to a subframe;

FIG. 15 is a diagram for an example of resource allocation for E-PDCCH and a process of receiving E-PDCCH;

FIG. 16 is a diagram for an example of a rule determining a transmission direction in a conflict subframe;

FIGS. 17 and 18 are diagrams for examples of a rule determining a transmission direction in a conflict subframe;

FIG. 19 is a diagram for an example of the number of symbols of a special subframe;

FIG. 20 is a diagram for an example of a method of transceiving a signal in a conflict subframe according to the present invention;

FIG. 21 is a diagram for an example of a method of transceiving a signal in a conflict subframe according to the present invention;

FIG. 22 is a diagram for an example of a method of transceiving a signal according to the present invention in case of a conflict subframe consisting of a special subframe and a DL subframe or an UL subframe;

FIG. 23 is a diagram for an example of a method of transceiving a signal in a FDD system according to the present invention;

FIG. 24 is a diagram for an example of a method of transceiving a signal according to the present invention in case that a specific subframe is reconfigured and used as a DL subframe;

FIG. 25 is a diagram for a base station and a user equipment applicable to the present invention.

### BEST MODE

### Mode for Invention

The following description of embodiments of the present invention may apply to various wireless access systems including CDMA (code division multiple access), FDMA (frequency division multiple access), TDMA (time division multiple access), OFDMA (orthogonal frequency division multiple access), SC-FDMA (single carrier frequency division multiple access) and the like. CDMA can be implemented with such a radio technology as UTRA (universal terrestrial radio access), CDMA 2000 and the like. TDMA can be implemented with such a radio technology as GSM/GPRS/EDGE (Global System for Mobile communications)/General Packet Radio Service/Enhanced Data Rates for GSM Evolution). OFDMA can be implemented with such a radio technology as IEEE 802.11 (Wi-Fi), IEEE 802.16 (WiMAX), IEEE 802.20, E-UTRA (Evolved UTRA), etc. UTRA is a part of UMTS (Universal Mobile Telecommunications System). 3GPP (3rd Generation Partnership Project) LTE (long term evolution) is a part of E-UMTS (Evolved UMTS) that uses E-UTRA and LTE-A (advanced) is an evolved version of 3GPP LTE. In the present specification, LTE system may indicate a system following 3GPP (3rd Generation Partnership Project) technical specification (TS) 36 series release 8. In the present specification, LTE-A system may indicate a system following 3GPP technical specification (TS) 36 series release 9 and 10. LTE(-A) system may indicate a system including both LTE system and LTE-A system. For clarity, the following description mainly concerns 3GPP LTE(-A) system, by which the technical idea of the present invention may be non-limited.

In a wireless communication system, a user equipment receives information from a base station in downlink (hereinafter abbreviated DL) and the user equipment transmits information to the base station in uplink (hereinafter abbreviated UL). The information transceived between the user equipment and the base station includes data and various control information. There exist various physical channels according to a type and a usage of the information transceived between the user equipment and the base station.

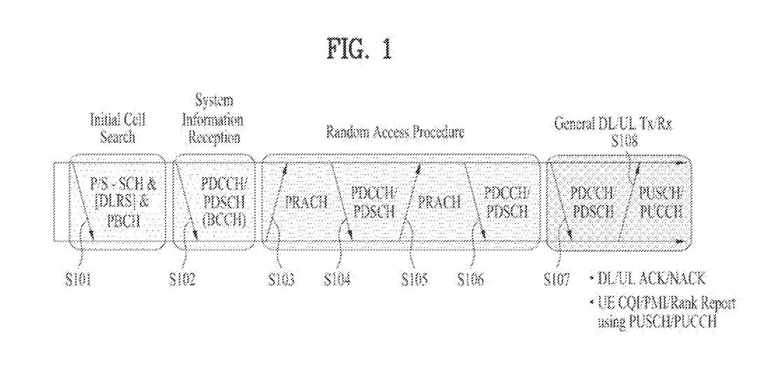

FIG. 1 is a diagram for explaining physical channels used for LTE (-A) system and a method of transmitting a signal using the same.

Referring to FIG. 1, if a power of a user equipment is turned on or the user equipment enters a new cell, the user equipment may perform an initial cell search job for matching synchronization with a base station and the like [S101]. To this end, the user equipment may receive a primary synchronization channel (P-SCH) and a secondary synchronization channel (S-SCH) from the base station, may match synchronization with the base station and may then obtain information such as a cell ID and the like. Subsequently, the user equipment may receive a physical broadcast channel (PBCH) from the base station and may be then able to obtain intra-cell broadcast information. Meanwhile, the user equipment may receive a downlink reference signal (DL RS) and may be then able to check a DL channel state.

Having completed the initial cell search, the user equipment may receive a physical downlink control channel (PDCCH) and a physical downlink shared control channel (PDSCH) according to the physical downlink control channel (PDCCH) and may be then able to obtain a detailed system information [S102].

Meanwhile, the user equipment may be able to perform a random access procedure to complete the access to the base station [S103 to S106]. To this end, the user equipment may transmit a specific sequence as a preamble via a physical random access channel (PRACH) [S103] and may be then able to receive a response message via PDCCH and a corresponding PDSCH in response to the random access [S104]. In case of a contention based random access, it may be able to perform a contention resolution procedure such as a transmission S105 of an additional physical random access channel and a channel reception S06 of a physical downlink control channel and a corresponding physical downlink shared channel.

Having performed the above mentioned procedures, the user equipment may be able to perform a PDCCH/PDSCH reception S107 and a PUSCH/PUCCH (physical uplink shared channel/physical uplink control channel) transmission S108 as a general uplink/downlink signal transmission procedure. Control information transmitted to a base station by a user equipment may be commonly named uplink control information (hereinafter abbreviated UCI). The UCI may include HARQ-ACK/NACK (Hybrid Automatic Repeat and reQuest Acknowledgement/Negative-ACK), SR (Scheduling Request), CQI (Channel Quality Indication), PMI (Precoding Matrix Indication), RI (Rank Indication) information and the like. The UCI is normally transmitted via PUCCH by periods. Yet, in case that both control information and traffic data need to be simultaneously transmitted, the UCI may be transmitted on PUSCH. Moreover, the UCI may be non-periodically transmitted in response to a request/indication made by a network.

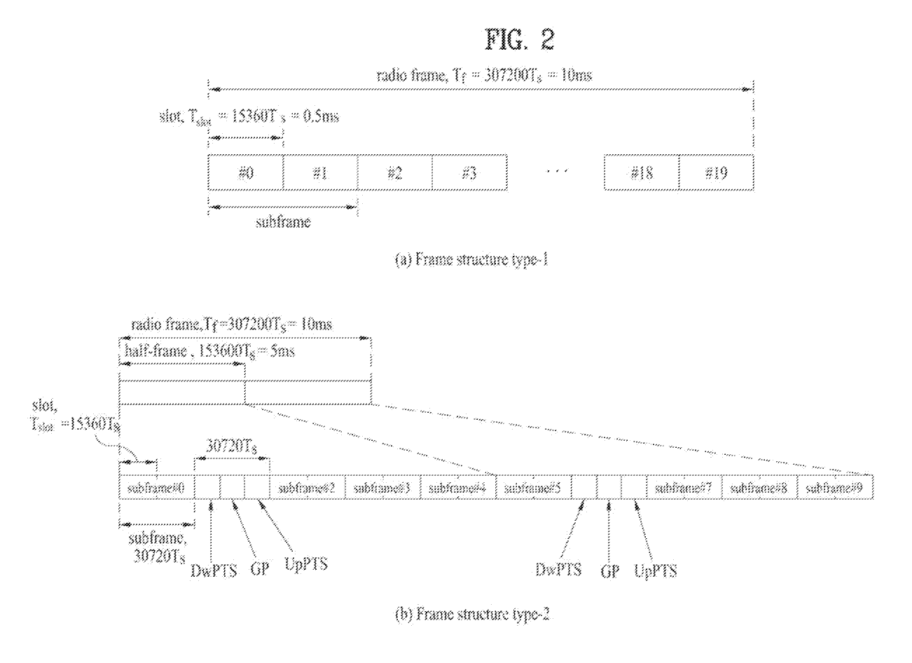

FIG. 2 is a diagram for a structure of a radio frame in LTE (-A) system. In a cellular OFDM radio packet communication system, UL/DL (uplink/downlink) data packet transmission is performed by a unit of subframe. And, one subframe is defined as a predetermined time interval including a plurality of OFDM symbols. In LTE(-A) system, a type 1 radio frame structure applicable to FDD (frequency division duplex) and a type 2 radio frame structure applicable to TDD (time division duplex) are supported.

FIG. 2 (a) is a diagram for a structure of a type 1 radio frame. A DL (downlink) radio frame includes 10 subframes. Each of the subframes includes 2 slots in time domain. And, a time taken to transmit one subframe is defined as a transmission time interval (hereinafter abbreviated TTI). For instance, one subframe may have a length of 1 ms and one slot may have a length of 0.5 ms. One slot may include a plurality of OFDM symbols in time domain and may include a plurality of resource blocks (RBs) in frequency domain. Since LTE (-A) system uses OFDMA in downlink, OFDM symbol is provided to indicate one symbol interval. The OFDM symbol may be named SC-FDMA symbol or symbol interval. Resource block (RB) is a resource allocation unit and may include a plurality of contiguous subcarriers in one slot.

The number of OFDM symbols included in one slot may vary in accordance with a configuration of CP (cyclic prefix). The CP may be categorized into an extended CP and a normal CP. For instance, in case that OFDM symbols are configured by the normal CP, the number of OFDM symbols included in one slot may correspond to 7. In case that OFDM symbols are configured by the extended CP, since a length of one OFDM symbol increases, the number of OFDM symbols included in one slot may be smaller than that of the case of the normal CP. In case of the extended CP, for instance, the number of OFDM symbols included in one slot may correspond to 6. If a channel status is unstable (e.g., a UE is moving at high speed), it may be able to use the extended CP to further reduce the inter-symbol interference.

When a normal CP is used, since one slot includes 7 OFDM symbols, one subframe includes 14 OFDM symbols. In this case, first 3 OFDM symbols of each subframe may be allocated to PDCCH (physical downlink control channel), while the rest of the OFDM symbols are allocated to PDSCH (physical downlink shared channel).

FIG. 2 (b) is a diagram for a structure of a downlink radio frame of type 2. A type 2 radio frame includes 2 half frames. Each of the half frame includes 5 subframes, a DwPTS (downlink pilot time slot), a GP (guard period), and an UpPTS (uplink pilot time slot). Each of the subframes includes 2 slots. The DwPTS is used for initial cell search, synchronization, or channel estimation in a user equipment. The UpPTS is used for channel estimation in a base station and matching an uplink transmission synchronization of a user equipment. For instance, the UpPTS may transmit an SRS sounding reference signal) for channel estimation of a base station and a PRACH (physical random access channel) carrying a random access preamble used for matching UL transmission synchronization. The guard period is a period for eliminating interference generated in uplink due to multi-path delay of a downlink signal between uplink and downlink. Table 1 shows an example of UL-DL (uplink-downlink) configuration of subframes in a radio frame in TDD mode.

TABLE 1

| Uplink-downlink | Downlink-to-Uplink | Subframe number | | | | | | | | | |
|---|---|---|---|---|---|---|---|---|---|---|---|
| configuration | Switch-point periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, ‘D’ indicates a DL subframe (DL SF), ‘11’ indicates a UL subframe (UL SF) and ‘S’ indicates a special subframe. The special subframe includes a DI, period (e.g., DwPTS), a guard period (e.g., a GP) and an UL period (e.g., UpPTS). Table 2 shows an example of configuration of the special subframe.

TABLE 2

| | Normal cyclic prefix in downlink | | | Extended cyclic prefix in downlink | | |
|---|---|---|---|---|---|---|
| | | UpPTS | | | UpPTS | |
| Special | | Normal | Extended | | Normal | Extended |
| subframe | | cyclic prefix | cyclic prefix | | cyclic prefix | cyclic prefix |
| configuration | DwPTS | in uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

The above-described structures of the radio frame are exemplary only. And, the number of subframes included in a radio frame, the number of slots included in the subframe and the number of symbols included in the slot may be modified in various ways.

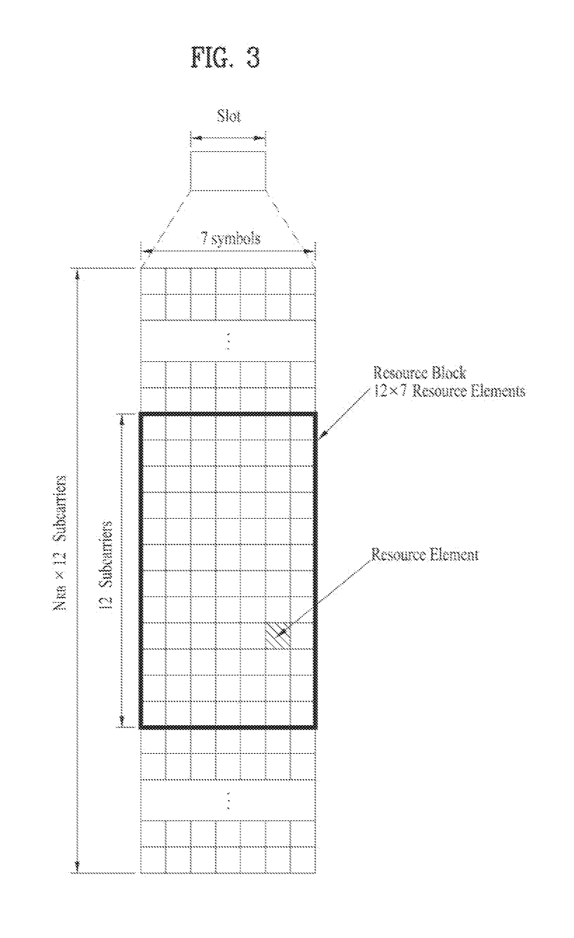

FIG. 3 is a diagram for one example of a resource grid for a downlink slot in LTE (-A) system.

Referring to FIG. 3, one downlink slot includes a plurality of OFDM symbols in time domain. In this case, one downlink (DL) slot includes 7 OFDM symbols and one resource block (RB) includes 12 subcarriers in frequency domain, by which the present invention may be non-limited. Each element on a resource grid is called a resource element. One resource block includes 12×7 resource elements. The number N_{DL} of resource blocks included in a DL slot may depend on a DL transmission bandwidth. And, the structure of an uplink (UL) slot may be identical to that of the DL slot.

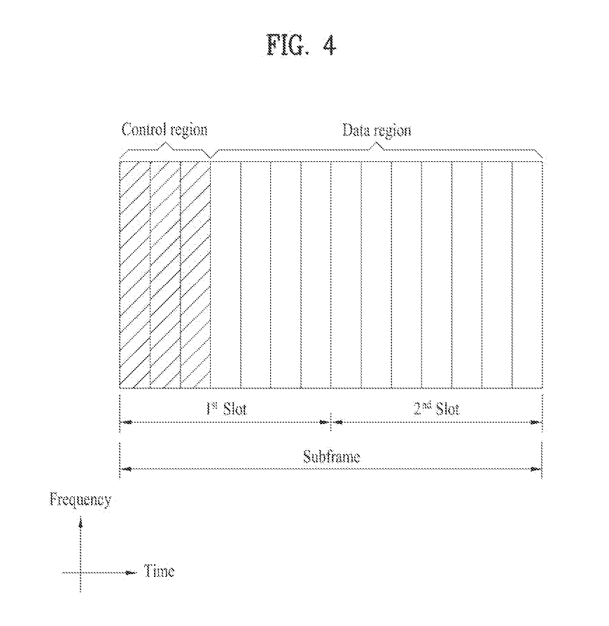

FIG. 4 is a diagram for a structure of a downlink subframe in LTE (-A) system.

Referring to FIG. 4, Maximum 3(4) OFDM symbols situated in a head part of a first slot of one subframe correspond to a control region to which control channels are assigned. The rest of OFDM symbols correspond to a data region to which PDSCH (physical downlink shared channel) is assigned. A basic resource unit of the data region corresponds to RB. Examples of DL control channels used by LTE(-A) system may include PCFICH (Physical Control Format Indicator Channel), PDCCH (Physical Downlink Control Channel), PHICH (Physical hybrid ARQ indicator Channel) and the like.

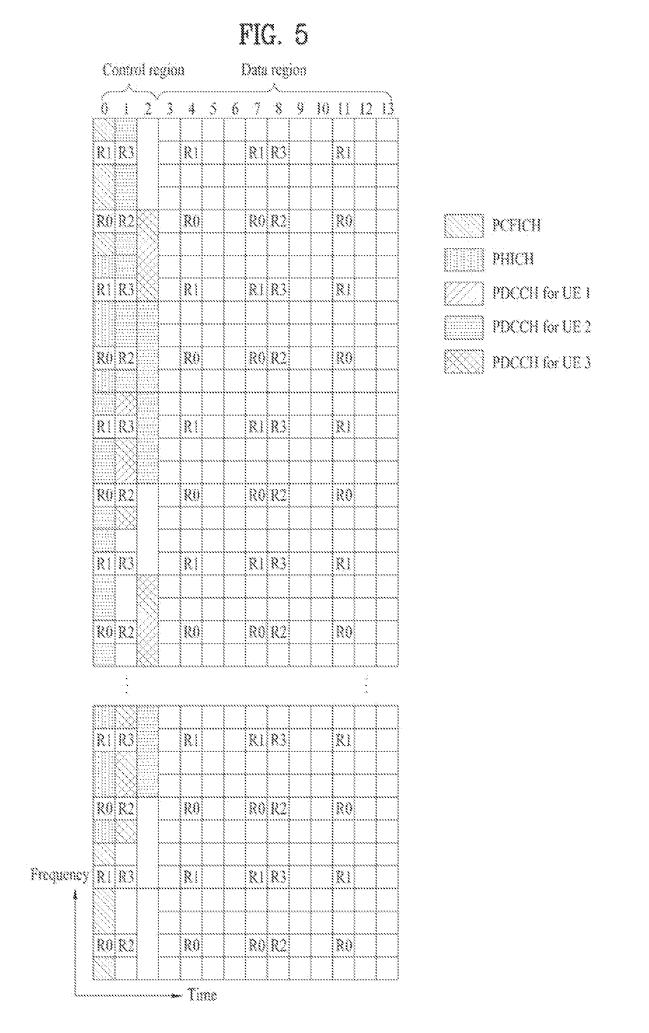

FIG. 5 is a diagram for a control channel assigned to a downlink subframe. In the drawing, R1 to R4 indicates a CRS (cell-specific reference signal or cell-common reference signal) for an antenna port 0 to 3, respectively. The CRS is transmitted on a whole band in every subframe and is fixed in a prescribed pattern in a subframe. The CRS is used to measure a channel and demodulate a downlink signal.

Referring to FIG. 5, the PCFICH is transmitted in a first OFDM symbol of a subframe and carries information on the number of OFDM symbols used for a transmission of a control channel within the subframe. The PCFICH consists of 4 REGs and each of the REGs is equally distributed to a control region based on a cell ID. The PCFICH indicates a value of 1 to 3 (or 2 to 4) and is modulated by QPSK (quadrature phase shift keying). The PHICH carries HARQ ACK/NACK signal in response to UL transmission. The PHICH is assigned to remaining REGs in one or more OFDM symbols configured by PHICH duration except a CRS and PCFICH (a first OFDM symbol). The PHICH is assigned to 3 REGs maximally distributed in frequency domain.

PDCCH is assigned to first n number of OFDM symbols (hereinafter control region) of a subframe. In this case, the n is an integer equal to or greater than 1 and is indicated by the PCFICH. Control information carried on PDCCH may be called downlink control information (hereinafter abbreviated DCI). A DCI format is defined by a format 0, 3, 3A and 4 for UL and a format 1, 1A, 1B, 1C, 1D, 2, 2A, 2B, 2C, 2D and the like for DL. The DCI format selectively includes such information as hopping flag, RB allocation, MCS (modulation coding scheme), RV (redundancy version), NDI (new data indicator), TPC (transmit power control), cyclic shift DM-RS (demodulation reference signal), CQI (channel quality information) request, HARQ process number, TPMI (transmitted precoding matrix indicator), PMI (precoding matrix indicator) confirmation and the like according to a usage of the DCI format.

PDCCH is able to carry resource allocation information and transmission format of DL-SCH (downlink shared channel), resource allocation information and transmission format of UL-SCH (uplink shared channel), paging information on PCH (paging channel), system information on DL-SCH, resource allocation information of an upper layer control message such as a random access response transmitted on PDSCH, a set of transmission power control commands for individual user equipments within a random user equipment group, a transmission power control command, activation of VoIP (voice over IP) indication information and the like. A plurality of PDCCHs can be transmitted in a control region and a user equipment is able to monitor a plurality of the PDCCHs. PDCCH is transmitted in an aggregation of a plurality of contiguous control channel elements (CCEs). CCE is a logical assignment unit used to provide PDCCH with a code rate in accordance with a state of a radio channel. CCE corresponds to a plurality of REGs (resource element groups). A format of PDCCH and the number of bits of PDCCH are determined depending on the number of CCEs. A base station determines a PDCCH format according to a DCI to be transmitted to a user equipment and attaches a CRC (cyclic redundancy check) to control information. CRC is masked with an identifier (e.g., RNTI (radio network temporary identifier)) according to an owner or usage of PDCCH. If the PDCCH is provided for a specific user equipment, the CRC can be masked with a unique identifier of the user equipment, i.e., C-RNTI (i.e., Cell-RNTI). If the PDCCH is provided for a paging message, the CRC can be masked with a paging indication identifier (e.g., P-RNTI (Paging-RNTI)). If the PDCCH is provided for system information (more specifically, for a system information block (SIB)), the CRC can be masked with a system information identifier (e.g., SI-RNTI (system information-RNTI). If the PDCCH is provided for a random access response, CRC can be masked with RA-RNTI (random access-RNTI).

A plurality of PDCCHs can be transmitted in one subframe. Each of a plurality of the PDCCHs is transmitted using one or more CCEs (control channel elements) and each CCE corresponds to 4 resource elements of 9 sets. The 4 resource elements are called a REG (resource element group). 4 QPSK symbols are mapped to one REG. A resource element allocated to a reference signal is not included in an REG Hence, the total number of REG in a given OFDM symbol varies according to whether there exists a cell-specific reference signal.

Table 3 shows the number of CCE, the number of REG and the number of PDCCH bits according to a PDCCH format.

TABLE 3

| | Number | | Number of PDCCH |
|---|---|---|---|
| PDCCH format | of CCE (n) | Number of REG | bits |
| 0 | 1 | 9 | 72 |
| 1 | 2 | 18 | 144 |
| 2 | 4 | 36 | 288 |
| 3 | 8 | 72 | 576 |

CCEs are used in a manner of being contiguously numbered. In order to simplify a decoding process, PDCCH including a format configured by n CCEs can start on a CCE having a number identical to multiple of the n only. The number of CCEs used for a transmission of a specific PDCCH is determined by a base station in accordance with a channel condition. For instance, if PDCCH is used for a user equipment of a good DL channel (e.g., a channel close to a base station), one CCE may be sufficient to transmit the specific PDCCH. Yet, in case of a user equipment of a poor channel (e.g., a channel close to a cell boundary), it may use 8 CCEs to obtain sufficient robustness. And, a power level of PDCCH can be adjusted according to a channel condition.

In LTE(-A) system, a CCE position of a limited set at which PDCCH is able to be positioned is defined for each user equipment. The CCE position of the limited set where a user equipment is able to search for PDCCH of the user equipment can be called a search space (SS). In LTE(-A) system, a search space has a size different according to each PDCCH format. The search space is configured with a UE-specific search space and a common search space. Since a base station does not provide a user equipment with information on a position of PDCCH in a search space, the user equipment monitors a set of PDCCH candidates in the search space and finds out PDCCH of the user equipment. In this case, monitoring the set of the PDCCH candidates means to make an attempt at decoding the received PDCCH candidates according to each DCI format by the user equipment. Finding out PDCCH in the search space is called a blind decoding or blind detection. Through the blind decoding, the user equipment performs identification of PDCCH transmitted to the user equipment and decoding of control information transmitted on the PDCCH at the same time. For instance, when PDCCH is de-masked with C-RNTI, if there is no CRC error, it indicates that the user equipment has detected the PDCCH of the user equipment. A UE-specific search space (USS) is individually set for each user equipment and a size of a common search space (CSS) is known to all user equipments. The USS and the CSS can be overlapped with each other. Due to a small search space, it may happen that a base station is unable to reserve CCE resources enough to transmit PDCCH to all user equipments attempting to transmit PDCCH in a given subframe. This is because resources remaining after assignment of CCE positions may not be included in a search space of a specific user equipment. In order to minimize this blocking that may be kept in a next subframe, a UE-specific hopping sequence may apply to a start point of the UE-specific search space.

Table 4 shows sizes of a common search space (CSS) and a UE-specific search space (USS).

TABLE 4

| | | Number of | Number of |
|---|---|---|---|
| | | candidates in | candidates in UE- |
| | Number of CCEs | common search | specific search |
| PDCCH format | (n) | space | space |
| 0 | 1 | — | 6 |
| 1 | 2 | — | 6 |
| 23 | 4 | 4 | 2 |
| | 8 | 2 | 2 |

In order to reduce a calculation load of a user equipment due to a blind decoding attempt count, a user equipment does not perform searches in accordance with all the defined DCI formats at the same time. In particular, the user equipment always searches a UE-search space for DCI format 0 and DCI format 1A. In doing so, although the DCI format 0 and the DCI format 1A are equal to each other in size, the user equipment is able to identify DCI formats using flags included in a message. Moreover, DCI formats other than the DCI format 0 or the DCI format 1A may be requested to the user equipment (e.g., DCI format 1, DCI format 1B and DCI format 2 according to a PDSCH transmission mode configured by a base station). A user equipment may be able to search a common search space for DCI format 1A and DCI format 1C. Moreover, the user equipment may be set to search for DCI format 3 or DCI format 3A. In this case, although the DCI format 3/3A may have the same size of the DCI format 0/1A, the user equipment may be able to identify a DCI format using CRC scrambled by an identifier different from each other (common) other than a UE-specific identifier. A PDSCH transmission scheme according to a transmission mode and information contents of DCI formats are described in the following.

Transmission mode (TM)
Transmission mode 1: transmission from a single base station antenna port
Transmission mode 2: transmit diversity
Transmission mode 3: open-loop spatial multiplexing
Transmission mode 4: closed-loop spatial multiplexing
Transmission mode 5: Multi-user MIMO
Transmission mode 6: Closed-loop rank=1 precoding
Transmission mode 7: single antenna port (port 5) transmission
Transmission mode 8: double layer transmission (port 7 and 8) or single antenna port (port 7 or 8) transmission
Transmission mode 9 to 10: maximum 8 layers transmission (port 7 to 14) or single antenna transmission (port 7 or 8)

DCI Format
Format 0: Resource grants for the PUSCH transmissions (uplink)
Format 1: Resource assignments for single codeword PDSCH transmissions (transmission modes 1, 2 and 7)
Format 1A: Compact signaling of resource assignments for single codeword PDSCH (all modes)
Format 1B: Compact resource assignments for PDSCH using rank-1 closed loop precoding (mode 6)
Format 1C: Very compact resource assignments for PDSCH (e.g. paging/broadcast system information)
Format ID: Compact resource assignments for PDSCH using multi-user MIMO (mode 5)
Format 2: Resource assignments for PDSCH for closed-loop MIMO operation (mode 4)
Format 2A: Resource assignments for PDSCH for open-loop MIMO operation (mode 3)
Format 3/3A: Power control commands for PUCCH and PUSCH with 2-bit/1-bit power adjustment
Format 4: Resource grant for PUSCH transmission (UL) in a cell configured in multi-antenna port transmission mode

A user equipment can be semi-statically configured by upper layer signaling in order to receive transmission of PDSCH data which is scheduled via PDCCH according to 10 transmission modes.

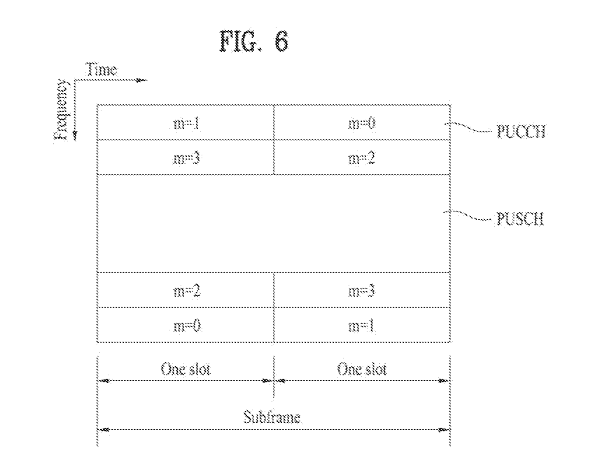

FIG. 6 is a diagram for a structure of an uplink subframe in LTE (-A) system.

Referring to FIG. 6, an UL subframe includes a plurality of (e.g., 2) slots. A slot may include a different number of SC-FDMA symbols according to a length of a CP. As an example, in case of a normal CP, a slot can include 7 SC-FDMA symbols. An UL subframe can be divided into a data region and a control region in frequency domain. The data region includes PUSCH and is used to transmit a data signal such as audio and the like. The control region includes PUCCH and is used to transmit control information. PUCCH includes an RP pair (e.g., m=0, 1, 2 and 3) situating at both ends of the data region in a frequency axis and hops on a slot boundary. The control information includes HARQ ACK/NACK, CQI (channel quality information), PMI (precoding matrix indicator), RI (rank indication) and the like.

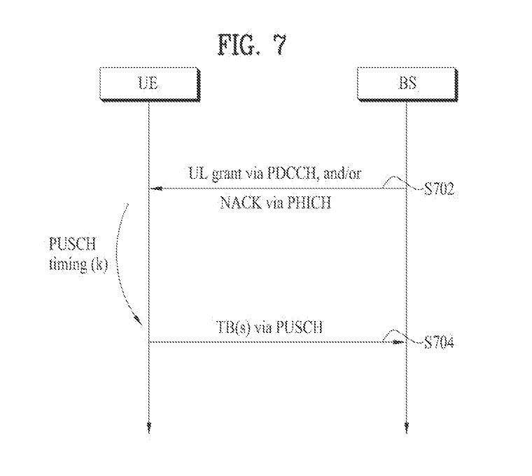

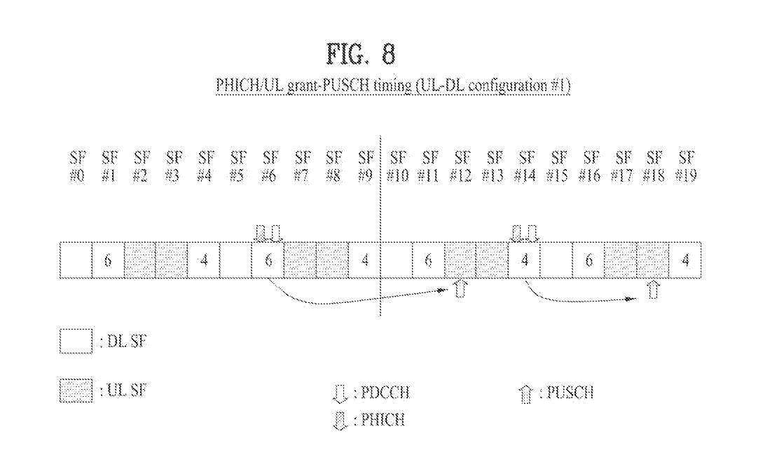

FIGS. 7 and 8 are diagrams for examples of PHICH/UL grant-PUSCH timing. PUSCH can be transmitted in response to PDCCH (UL grant) and/or PHICH (NACK).

Referring to FIG. 7, a user equipment can receive PDCCH (UL grant) and/or PHICH (NACK) [S702]. In this case, NACK corresponds to ACK/NACK response for a previous PUSCH transmission. In this case, a user equipment undergoes a process (e.g., transport block (TB) coding, transport block-codeword swapping, PUSCH resource allocation and the like) for PUSCH transmission and may be able to initially transmit/retransmit one or a plurality of transport blocks via PUSCH after a k subframe [S704]. The present example assumes a normal HARQ operation that transmits PUSCH one time. In this case, PHICH/UL grant corresponding to the PUSCH transmission exists in an identical subframe. Yet, in case of performing subframe bundling in a manner that PUSCH is transmitted several times via a plurality of subframes, the PHICH/UL grant corresponding to the PUSCH transmission may exist in a subframe different from each other.

Specifically, if the PHICH/UL grant is detected in a subframe n, a user equipment can transmit PUSCH in a subframe n+k. In case of FDD system, k may have a fixed value (e.g., 4). In case of TDD system, k may have a different value according to a UL-DL configuration. Table 5 shows an UAI (uplink association index) (k) for PUSCH transmission in TDD LTE(-A) system. The UAI may indicate a space between a DL subframe in which the PHICH/UL grant is detected and a UL subframe associated with the DL subframe. Specifically, if the PHICH/UL grant is detected in a subframe n, a user equipment can transmit PUSCH in a subframe n+k.

TABLE 5

| TDD UL/DL | subframe number n | | | | | | | | | |
|---|---|---|---|---|---|---|---|---|---|---|
| Configuration | 0 | 1 | 2 | 3 | 4 | 5 | 6 | 7 | 8 | 9 |
| 0 | 4 | 6 | | | | 4 | 6 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

Table 6 shows timing of detecting PHICH/UL grant detected by a user equipment in case of performing subframe bundling in TDD UL-DL configuration #0, #1 and #6. Specifically, if the PHICH/UL grant is detected in a subframe n−1, a user equipment can transmit PUSCH in a subframe n+k in a manner of bundling the PUSCH.

TABLE 6

| TDD UL/DL | DL subframe number n | | | | | | | | | |
|---|---|---|---|---|---|---|---|---|---|---|
| Configuration | 0 | 1 | 2 | 3 | 4 | 5 | 6 | 7 | 8 | 9 |
| 0 | 9 | 6 | | | | 9 | 6 | | | |
| 1 | | 2 | | | 3 | | 2 | | | 3 |
| 6 | 5 | 5 | | | | 6 | 6 | | | 8 |

FIG. 8 shows an example of PUSCH transmission timing in case that UL-DL configuration #1 is set. In the drawing, an SF #0 to #9 and an SF #10 to #19 correspond to a radio frame, respectively. In the drawing, a number in a box indicates an UL subframe associated with a DL subframe in terms of the DL subframe. For instance, PUSCH for PHICH/UL grant in an SF #6 is transmitted in an SF #6+6 (=SF #12) and PUSCH for PHICH/UL grant in an SF #14 is transmitted in an SF #14+4 (=SF #18).

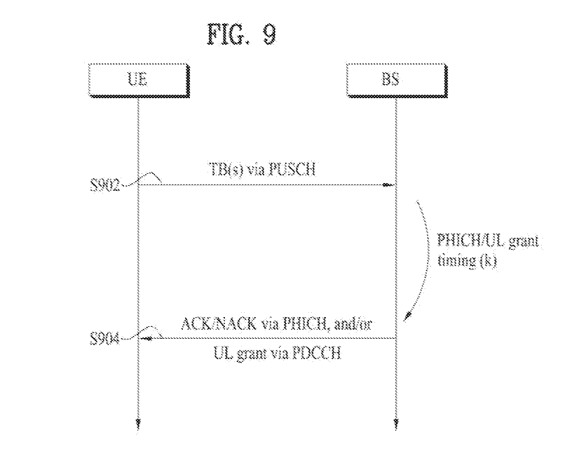

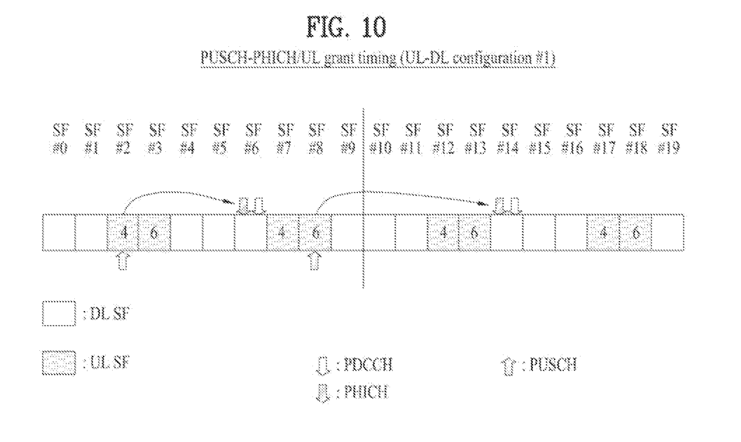

FIGS. 9 and 10 are diagrams for PUSCH-PHICH/UL grant timing. PHICH is used to transmit DL ACK/NACK. In this case, the DL ACK/NACK corresponds to ACK/NACK transmitted in DL in response to UL data (e.g., PUSCH).

Referring to FIG. 9, a user equipment transmits a PUSCH signal to a base station [S902]. In this case, the PUSCH signal is used to transmit one or a plurality of (e.g., 2) transport blocks (TBs) according to a transmission mode. A base station undergoes a process (e.g., ACK/NACK generation, ACK/NACK resource allocation and the like) to transmit ACK/NACK and may be then able to transmit the ACK/NACK to a user equipment via PHICH after a k subframe in response to the PUSCH transmission [S904]. The ACK/NACK includes reception response information on the PUSCH signal of the step S902. If a response for the PUSCH transmission corresponds to NACK, a base station can transmit UL grant PDCCH to a user equipment to transmit PUSCH again after the k subframe [S904]. The present example assumes a normal HARQ operation that transmits PUSCH one time. In this case, PHICH/UL grant corresponding to the PUSCH transmission can be transmitted in an identical subframe. Yet, in case of performing subframe bundling, the PHICH/UL grant corresponding to the PUSCH transmission can be transmitted in a subframe different from each other.

Table 7 shows an UAI (uplink association index) (k) for PUSCH transmission in LTE (-A) system. Table 7 indicate a space between a DL subframe in which the PHICH/UL grant exists and a UL subframe associated with the DL subframe. Specifically, PHICH/UL grant of a subframe i corresponds to PUSCH transmission in a subframe i−k.

TABLE 7

| TDD UL/DL | subframe number i | | | | | | | | | |
|---|---|---|---|---|---|---|---|---|---|---|
| Configuration | 0 | 1 | 2 | 3 | 4 | 5 | 6 | 7 | 8 | 9 |
| 0 | 7 | 4 | | | | 7 | 4 | | | |
| 1 | | 4 | | | 6 | | 4 | | | 6 |
| 2 | | | | 6 | | | | | 6 | |
| 3 | 6 | | | | | | | | 6 | 6 |
| 4 | | | | | | | | | 6 | 6 |
| 5 | | | | | | | | | 6 | |
| 6 | 6 | 4 | | | | 7 | 4 | | | 6 |

FIG. 10 shows an example of PHICH/UL grant transmission timing in case that UL-DL configuration #1 is set. In the drawing, an SF #0 to #9 and an SF #10 to #19 correspond to a radio frame, respectively. In the drawing, a number in a box indicates an DL subframe associated with a UL subframe in terms of the UL subframe. For instance, PHICH/UL grant for PUSCH in an SF #6 is transmitted in an SF #2+4 (=SF #6) and PHICH/UL grant for PUSCH in an SF #8 is transmitted in an SF #8+6 (=SF #14).

In the following, PHICH resource allocation is explained. If PUSCH is transmitted in a subframe #n, a user equipment determines a PHICH resource corresponding to a subframe+(n+k_{PHICH}). In FDD system, k_{PHICH} has a fixed value (e.g., 4). In TDD system, k_{PHICH} has a different value according to UL-DL configuration. Table 10 shows a k_{PHICH} value for TDD. It is identical to value shown in Table 7.

TABLE 8

| TDD UL/DL | UL subframe index n | | | | | | | | | |
|---|---|---|---|---|---|---|---|---|---|---|
| Configuration | 0 | 1 | 2 | 3 | 4 | 5 | 6 | 7 | 8 | 9 |
| 0 | | | 4 | 7 | 6 | | | 4 | 7 | 6 |
| 1 | | | 4 | 6 | | | | 4 | 6 | |
| 2 | | | 6 | | | | | 6 | | |
| 3 | | | 6 | 6 | 6 | | | | | |
| 4 | | | 6 | 6 | | | | | | |
| 5 | | | 6 | | | | | | | |
| 6 | | | 4 | 6 | 6 | | | 4 | 7 | |

A PHICH resource is given by [PHICH group index, orthogonal sequence index]. The PHICH group index and the orthogonal sequence index are determined using (i) a smallest PRB index used for transmitting PUSCH and (ii) a value of 3-bit field for DMRS (demodulation reference signal) cyclic shift. (i) and (ii) are indicated by UL grant PDCCH.

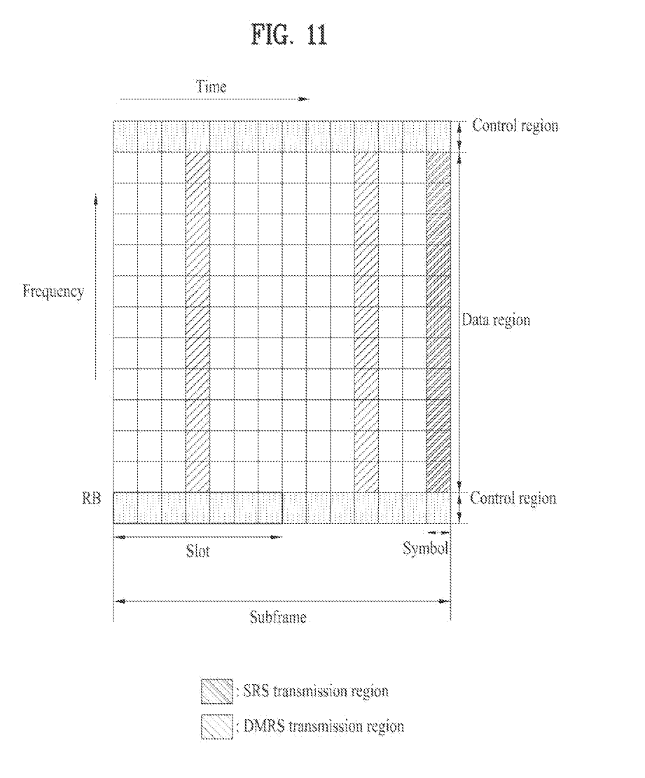

FIG. 11 is a diagram for an example of a reference signal used for an uplink subframe in LTE system.

Referring to FIG. 11, a user equipment can periodically or non-periodically transmit an SRS (sounding reference signal) to estimate a channel for an UL band (sub band) except a band on which PUSCH is transmitted or obtain information on a channel corresponding to a whole UL bandwidth (wide band). In case of periodically transmitting the SRS, a period can be determined via an upper layer signal. In case of non-periodically transmitting the SRS, a base station can indicate the transmission of the SRS using an ‘SRS request’ field of an UL-DL DCI format on PDCCH or trigger the transmission of the SRS using a triggering message. In case of a non-periodic SRS, a user equipment can transmit the SRS only when the SRS is indicated via PDCCH or a triggering message is received. As shown in FIG. 11, a region capable of receiving an SRS in a subframe corresponds to a period at which an SC-FDMA symbol, which is located at the last of a time axis in the subframe, is situated. In case of a TDD special subframe, an SRS can be transmitted via UL period (e.g., UpPTS). In case of a subframe configuration allocating a single symbol to UL period (e.g., UpPTS), an SRS can be transmitted via the last symbol. In case of a subframe configuration allocating 2 symbols, an SRS can be transmitted via the last one or two symbols. SRSs of many user equipments transmitted to the last SC-FDMA of an identical subframe can be distinguished from each other according to a frequency position. Unlike PUSCH, an SRS does not perform DFT (discrete Fourier Transform) calculation used for converting into SC-FDMA and the SRS is transmitted without using a precoding matrix which is used by PUSCH.

Moreover, a region to which a DMRS (demodulation reference signal) is transmitted in a subframe corresponds to a period at which an SC-FDMA symbol, which is located at the center of each slot in a time axis, is situated. Similarly, the DMRS is transmitted via a data transmission band on a frequency axis. For instance, the DMRS is transmitted in a 4^{th} SC-FDMA symbol and an 11^{th} SC-FDMA symbol in a subframe to which a normal cyclic prefix is applied.

A DMRS can be combined with transmission of PUSCH or PUCCH. An SRS is a reference signal transmitted to a base station by a user equipment for UL scheduling. The base station estimates an UL channel using the received SRS and uses the estimated UL channel for the UL scheduling. The SRS is not combined with the transmission of PUSCH or PUCCH. A basic sequence of an identical type can be used for the DMRS and the SRS. Meanwhile, in case of performing UL multi-antenna transmission, a precoding applied to a DMRS may be identical to a precoding applied to PUSCH.

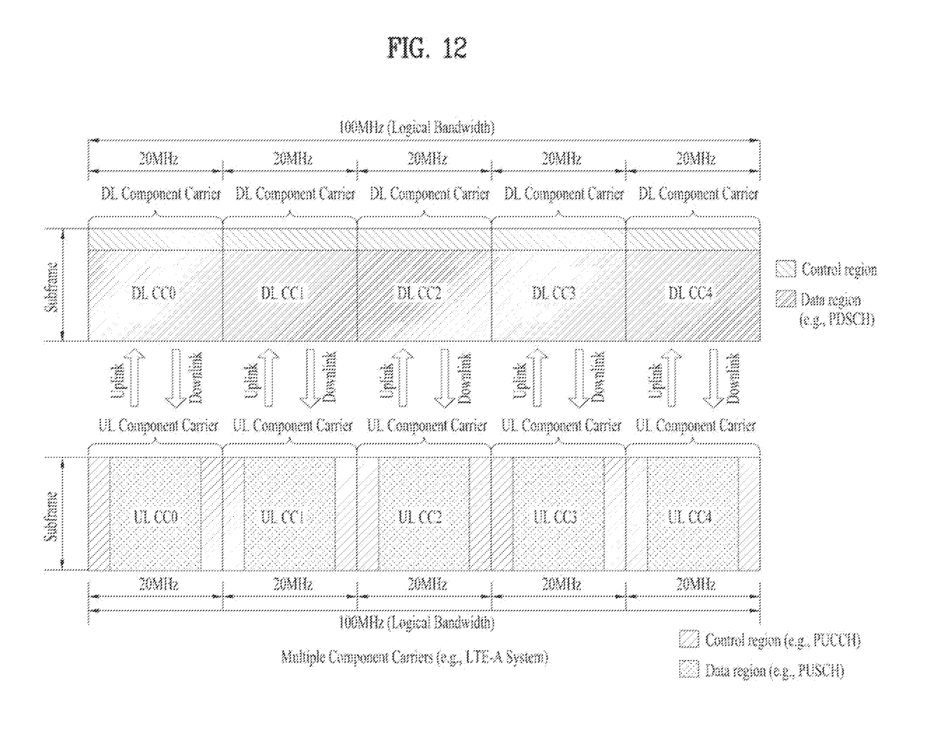

FIG. 12 is a diagram for an example of a carrier aggregation (CA) communication system.

Referring to FIG. 12, it is able to support a wider UL/DL bandwidth in a manner of collecting a plurality of UL/DL component carriers (CCs). A technology of collecting and using a plurality of the component carriers is called a carrier aggregation or bandwidth aggregation. A component carrier can be comprehended as a carrier frequency (or center carrier, center frequency) for a corresponding frequency block. Each of a plurality of the component carriers can be adjacent or non-adjacent to each other in frequency domain. A bandwidth of each component carrier can be independently determined. It may configure an asymmetrical carrier aggregation of which the number of UL CCs is different from the number of DL CCs. For instance, there are 2 DL CCs and 1 UL CC, asymmetrical carrier aggregation can be configured in a manner that the DL CC corresponds to the UL CC by 2:1. A link between a DL CC and an UL CC is fixed in a system or can be semi-statically configured. Although a whole system band consists of N number of CCs, a frequency band capable of being monitored/received by a specific user equipment can be restricted to M N) number of CCs. Various parameters for carrier aggregation can be configured by a cell-specific, a UE group-specific or a UE-specific scheme.

Meanwhile, control information can be configured to be transceived on a specific CC only. This sort of specific CC is called a primary CC (PCC) and the rest of CCs are called a secondary CC (SCC). The PCC can be used for a user equipment to perform an initial connection establishment process or a connection re-establishment process. The PCC may correspond to a cell indicated in a handover process. The SCC can be configured after an RRC connection is established and can be used to provide an additional radio resource. As an example, scheduling information can be configured to be transceived via a specific CC only. This sort of scheduling scheme is called cross-carrier scheduling (or cross-CC scheduling). If the cross-CC scheduling is applied, PDCCH for DL assignment is transmitted on a DL CC #0 and corresponding PDSCH can be transmitted on a DL CC #2. Such a terminology as a ‘component carrier’ can be replaced with a different equivalent terminology such as a carrier, a cell or the like.

For a cross-CC scheduling, a CIF (carrier indicator field) is used. Configuration for presence or non-presence of a CIF in PDCCH can be semi-statically and UE-specifically (or UE group-specifically) enabled by upper layer signaling (e.g., RRC signaling). A basic of PDCCH transmission can be summarized as follows.
CIF disabled: PDCCH on a DL CC allocates a PDSCH resource on the same DL CC and a PUSCH resource on a solely linked UL CC
No CIF
CIF enabled: PDCCH on a DL CC can allocate a PDSCH or PUSCH resource on a single DL/UL CC among a plurality of aggregated DL/UL CCs using a CIF
LTE DCI format extended to have CIF
CIF (if configured) is a fixed x-bit field (e.g., x=3)
CIF (if configured) is fixed irrespective of a DCI format size

If a CIF exists, a base station can allocate a monitoring DL CC (set) to reduce complexity of blind detection of a user equipment side. For PDSCH/PUSCH scheduling, a user equipment can perform PDCCH detection/decoding on the corresponding DL CC only. And, a base station can transmit PDCCH on the monitoring DL CC (set) only. The monitoring DL CC set can be set by a UE-specific, a UE group-specific, or a cell-specific scheme. In this case, “monitoring CC (MCC)” can be replaced with an equivalent terminology such as a monitoring carrier, a monitoring cell, a scheduling carrier, a scheduling cell, a serving carrier, a serving cell or the like. DL CC carrying PDSCH corresponding to PDCCH and UL CC carrying PUSCH corresponding to PDCCH can be called a scheduled carrier, a scheduled cell or the like.

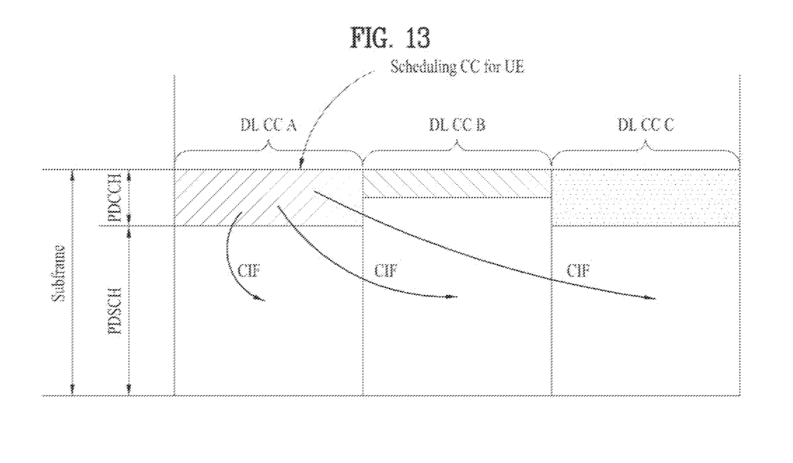

FIG. 13 is a diagram for an example of scheduling in case that a plurality of carriers are aggregated. FIG. 13 shows an example of a case that 3 DL CCs are aggregated with each other and a DL CC A is configured as a monitoring DL CC. DL CC A to DL CC C can also be called a serving CC, a serving carrier, a serving cell or the like. If a CIF is disabled, each DL CC can transmit PDCCH, which schedules PDSCH of each DL CC, without the CIF according to a PDCCH rule of LTE (-A) system (non-cross-CC scheduling). On the contrary, if a CIF is enabled by UE-specific (or UE group-specific or cell-specific) upper layer signaling, a specific CC (e.g., DL CC A) is able to transmit not only PDCCH, which schedules PDSCH of the DL CC A, but also PDCCH, which schedules PDSCH of a different DL CC, using the CIF (cross-CC scheduling). PDCCH is not transmitted on a DL CC B and a DL CC C, which are not configured as the monitoring DL CC.

As mentioned earlier with reference to FIG. 4 and FIG. 5, first n number of OFDM symbols of a subframe are used to transmit PDCCH, PHICH, PCFICH and the like corresponding to physical channels configured to transmit various control information and the rest of OFDM symbols are used to transmit PDSCH in LTE (-A) system. The number of symbols used to transmit a control channel in each subframe is dynamically delivered to a user equipment via such a physical channel as PCFICH and the like or is semi-statically delivered to the user equipment via RRC signaling. In this case, the n value can be configured by 1 to maximum 4 symbols according to a subframe characteristic and a system characteristic (FDD/TDD system bandwidth and the like). Meanwhile, in a legacy LTE system, PDCCH corresponding to a physical channel configured to transmit DL/UL scheduling and various control information has a limit of being transmitted via a restricted OFDM symbol(s) and the like. Hence, a system (e.g., a system appearing after 3GPP TS 36 series release 11) appearing after LTE (-A) is introducing an enhanced PDCCH (E-PDCCH), which is more freely multiplexed by PDSCH and FDM/TDM scheme.

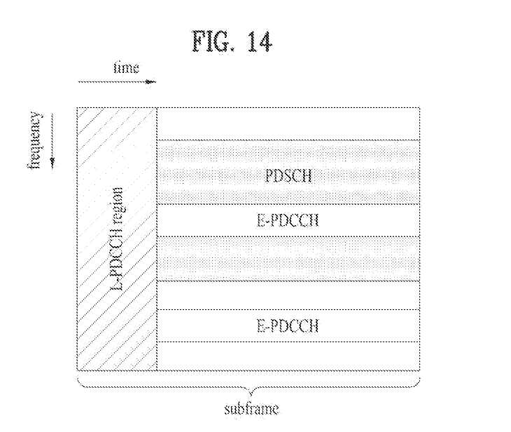

FIG. 14 is a diagram for an example of assigning a downlink physical channel to a subframe.

Referring to FIG. 14, PDCCH (for clarity, legacy PDCCH (L-PDCCH)) used in LTE (-A) system can be assigned to a control region (refer to FIG. 4 and FIG. 5) of a subframe. In the drawing, an L-PDCCH region corresponds to a region to which a legacy PDCCH is capable of being assigned. According to a context, the L-PDCCH region may correspond to a control region, a control channel resource region (i.e., CCE resource) to which PDCCH is capable of being actually assigned in the control region or a PDCCH search space. Meanwhile, PDCCH can be additionally assigned to a data region (e.g., a resource region for PDSCH, refer to FIG. 4 and FIG. 5). The PDCCH assigned to the data region is called E-PDCCH. As shown in FIG. 14, if a control channel resource is additionally secured by E-PDCCH, scheduling limitation resulted from a limited control channel resource of L-PDCCH region can be mitigated.

Specifically, E-PDCCH can be detected and demodulated based on a DM-RS. E-PDCCH may have a structure of being transmitted over a PRB pair on a time axis. More specifically, a search space (SS) to detect E-PDCCH can consist of one E-PDCCH candidate set or a plurality of E-PDCCH candidate sets (e.g., 2 E-PDCCH candidate sets). Each of a plurality of the E-PDCCH sets can occupy a plurality of PRB pairs (e.g., 2, 4 and 8 PRB pairs). E-CCE (enhanced CCE) including the E-PDCCH sets can be mapped in a localized or distributed form (according to whether one E-CCE is distributed to a plurality of the PRB pairs). And, in case that E-PDCCH-based scheduling is configured, it is able to designate a subframe in which E-PDCCH transmission/detection is performed. E-PDCCH can be configured in an USS only. A user equipment makes an attempt at detecting DCI in an L-PDCCH CSS and an E-PDCCH USS only in a subframe (hereinafter E-PDCCH subframe) in which the E-PDCCH transmission/detection is configured. On the contrary, the user equipment can make an attempt at detecting DCI in the L-PDCCH CSS and an L-PDCCH USS in a subframe (non-E-PDCCH) in which E-PDCCH transmission/detection is not configured.

In case of E-PDCCH, an USS can include K number of E-PDCCH set(s) (according to each CC/cell) in terms of a single user equipment. In this case, the K is equal to or greater than 1 and may become a number equal to or less than a specific upper limit (e.g., 2). And, each of the E-PDCCH sets can include N number of PRBs (belonging to a PDSCH region). In this case, a value of the N and a PRB resource/index constructing the value of the N can be independently (i.e., set-specifically) assigned according to E-PDCCH set. Hence, the number of E-CCE resources and indexes of the E-CCE resources constructing each E-PDCCH set can be (UE-specifically) set-specifically configured. A PUCCH resource/index linked to each of the E-CCE resources/indexes can also be (UE-specifically) set-specifically assigned by configuring an independent start PUCCH resource/index according to an E-PDCCH set. In this case, E-CCE may indicate a basic control channel unit of E-PDCCH consisting of a plurality of REs (belonging to a PRB in a PDSCH region). The E-CCE may have a different structure according to E-PDCCH transmission form. As an example, E-CCE for localized transmission can be configured using REs belonging to an identical PRB pair. On the contrary, E-CCE for distributed transmission can be configured using REs extracted from a plurality of PRB pairs. Meanwhile, in case of the E-CCE for localized transmission, an antenna port (AP) can be independently used according to E-CCE resource/index to perform optimized beamforming for each user. On the contrary, in case of the E-CCE for distributed transmission, in order for a plurality of users to commonly use an antenna port, an identical antenna port set can be repeatedly used by E-CCEs different from each other.

Similar to L-PDCCH, E-PDCCH carries DCI. For instance, E-PDCCH can carry DL scheduling information and UL scheduling information. E-PDCCH/PDSCH process and E-PDCCH/PUSCH process are identical or similar to what is explained with reference to the step S107 and the step S108 of FIG. 1. In particular, a user equipment receives E-PDCCH and can receive data/control information on PDSCH corresponding to the E-PDCCH. And, a user equipment receives E-PDCCH and can transmit data/control information on PUSCH corresponding to the E-PDCCH. Meanwhile, LTE (-A) system is choosing a scheme that PDCCH candidate region (hereinafter PDCCH search space) is reserved in advance within a control region and PDCCH of a specific user equipment is transmitted to a partial region of the PDCCH search space. By doing so, a user equipment can obtain PDCCH of the user equipment in the PDCCH search space via blind detection. Similarly, E-PDCCH can be transmitted over a part of reserved resources or all reserved resources as well.

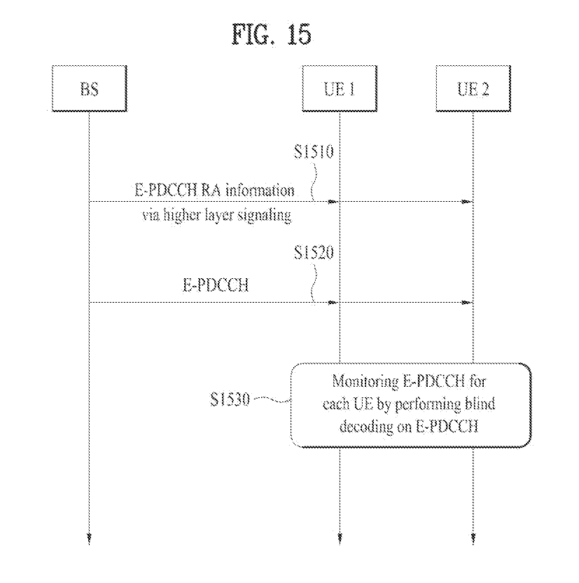

FIG. 15 is a diagram for an example of resource allocation for E-PDCCH and a process of receiving E-PDCCH.

Referring to FIG. 15, a base station transmits E-PDCCH resource allocation (RA) information to a user equipment [S1510]. The E-PDCCH resource allocation information can include RB (or VRB (virtual resource block)) allocation formation. The RB allocation information can be provided in an RB unit or an RBG (resource block group) unit. An RBG includes two or more contiguous RBs. The E-PDCCH resource allocation information can be transmitted using upper layer (e.g., radio resource control (RRC) layer) signaling. In this case, the E-PDCCH resource allocation information is used to reserve an E-PDCCH resource (region) in advance. Subsequently, the base station transmits E-PDCCH to the user equipment [S1520]. The E-PDCCH can be transmitted in a partial region or all regions of the E-PDCCH resource (e.g., M number of RBs) reserved in the step S1510. Hence, the user equipment monitors a resource (region) (hereinafter E-PDCCH search space) to which the E-PDCCH is capable of being transmitted [S1530]. The E-PDCCH search space can be provided by a part of the RB set allocated in the step S1510. In this case, monitoring includes a process of performing blind detection on a plurality of E-PDCCH candidates included in the search space.

In TDD LTE-A system (e.g., a system according to 3GPP technical standard (TS) 36 series release 9, 10), carrier aggregation (CA) between CCs including an identical UL-DL configuration is permitted only. Yet, in a beyond LTE-A system (e.g., a system according to a technical standard after 3GPP technical standard (TS) 36 series release 11), it may consider CA between CCs operating in UL-DL configurations different from each other for the purpose of improving cell coverage, traffic adaptation, throughput and the like. Meanwhile, in terms of a user equipment, simultaneous transmission and reception on an identical timing may be impossible or not permitted due to transmission and reception capability of the user equipment, other reason/purpose and the like. For this reason, the user equipment can be configured to perform either UL transmission or DL reception in such a time unit as a subframe (SF), a symbol and the like. For clarity, a UE (user equipment) operating (or performing transmission and reception) in a half-duplex scheme is called a “half-duplex UE” or simply a “HD-UE”.

In order to support CA between CCs including UL-DL configurations different from each other for the half-duplex UE (HD-UE), it may be necessary to have a rule for determining a direction (e.g., DL or UL) in subframes of which a transmission/reception direction (e.g., DL/UL) is different from each other between CCs. A subframe of which a transmission/reception direction is different from each other between aggregated CCs is defined as a “conflict subframe”. As an example of a rule determining a transmission direction in a conflict subframe, it may configure a transmission direction identical to that of a specific CC (e.g., PCC or PCell) to be permitted only in the conflict subframe. In this case, a CC having a transmission direction identical to that of the specific CC can be operated in the conflict subframe only.

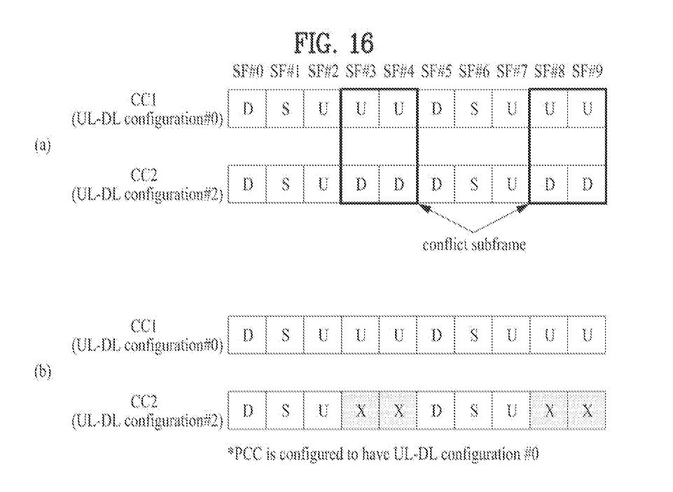

FIG. 16 is a diagram for an example of a rule determining a transmission direction in a conflict subframe. FIG. 16 shows an example that a half-duplex UE (HD UE) determines a transmission direction in a conflict subframe according to a specific CC (e.g., PCC or PCell). In FIG. 16, D, U and S indicates a downlink (DL) subframe, an uplink (UL) subframe and a special subframe, respectively. And, X indicates a subframe not performing signal transmission and reception. It may be called an X subframe.

Referring to FIG. 16, a user equipment configures a PCC, a CC1 and a CC2 to be carrier-aggregated by a TDD scheme. The PCC and the CC1 are configured by a UL-DL configuration #0 and the CC2 is configured by a UL-DL configuration #2. The PCC and the CC1 may correspond to CCs identical to each other or CCs different from each other. Hence, according to an example shown in Table 2, since a transmission direction of the CC1 and a transmission direction of the CC2 are different from each other in a subframe #3, a subframe #4, a subframe #8 and a subframe #9, the subframes may become conflict subframes. In this case, a half-duplex UE (HD UE) can determine a transmission direction according to a transmission direction of a specific CC (e.g., PCC or PCell) in the subframe #3, the subframe #4, the subframe #8 and the subframe #9. For instance, since the PCC is configured by the UL-DL configuration #0, the CC1 having UL-DL configuration identical to that of the PCC is operated in the conflict subframe. Yet, the CC2 having a different UL-DL configuration is not operated in the conflict subframe. Hence, transmission directions of the conflict subframes including the subframe #3, the subframe #4, the subframe #8 and the subframe #9 can be determined as UL, UL, UL and UL, respectively. The example shown in FIG. 16 is just an example. If CCs having UL-DL configuration different from the UL-DL configuration shown in FIG. 16 are aggregated with each other, an identical principle can also be applied.

As a different example of a rule determining a transmission direction in a conflict subframe, the transmission direction in the conflict subframe can be determined depending on scheduling of a base station (e.g., an eNB). For instance, it may receive UL grant PDCCH, which schedules UL data transmission to be performed in the conflict subframe. In this case, a half-duplex UE can determine the transmission direction in the conflict subframe as UL to perform the UL data transmission corresponding to the UL grant. Hence, if the half-duplex UE receives the UL grant, which schedules the UL data transmission to be performed in the conflict subframe, the half-duplex UE can operate a CC configured as UL for the conflict subframe only. Or, for instance, a conflict subframe can be configured as PHICH reception timing for UL data transmission. In this case, a half-duplex UE can determine a transmission direction of the conflict subframe as DL to receive PHICH. Hence, if the conflict subframe is configured as the PHICH reception timing, the half-duplex UE can operate a CC configured as DL only.

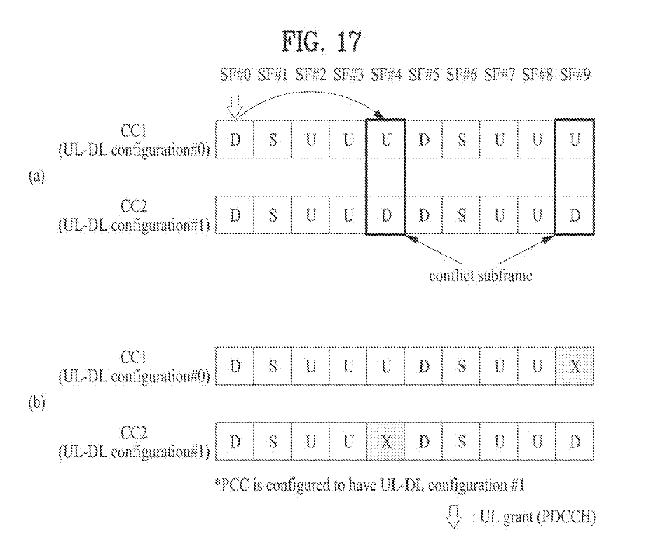

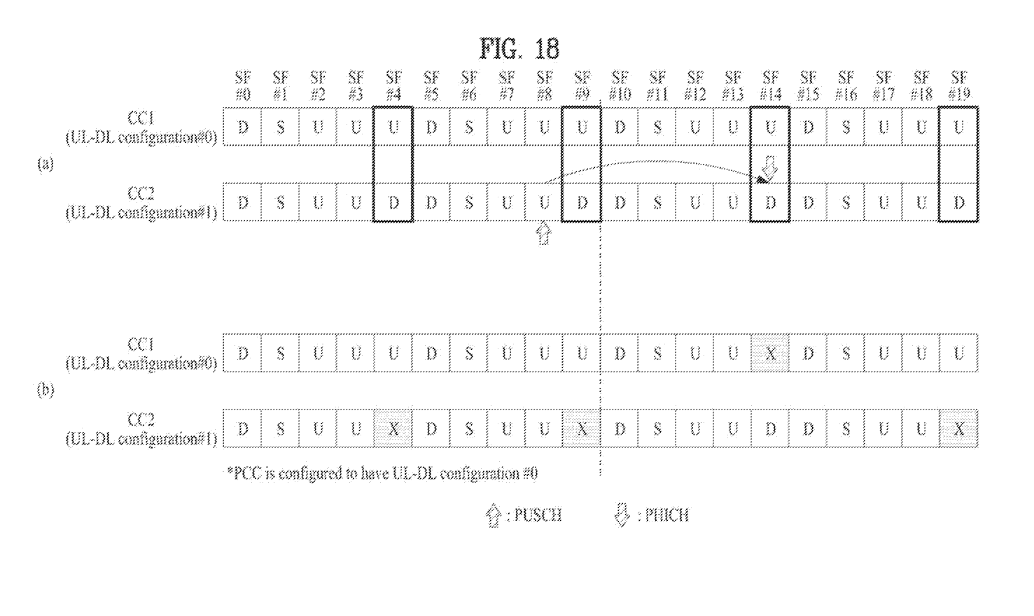

FIGS. 17 and 18 are diagrams for examples of a rule determining a transmission direction in a conflict subframe. FIG. 17 shows an example that a transmission direction of a conflict subframe is determined as UL to transmit UL data in case of receiving UL grant PDCCH, which schedules transmission of the UL data transmitted via the conflict subframe. FIG. 18 shows an example that a transmission direction of a conflict subframe is determined as DL to receive PHICH in case that the conflict subframe is configured as PHICH timing for UL data transmission. In FIG. 17, D, U and S indicate a downlink (DL) subframe, an uplink (UL) subframe and a special subframe, respectively. And, X indicates an X subframe.

Referring to FIG. 17, a user equipment configures a PCC, a CC1 and a CC2 to be carrier-aggregated by a TDD scheme. The CC1 is configured by a UL-DL configuration #0 and the PCC and the CC2 are configured by a UL-DL configuration #1. The PCC and the CC2 may correspond to CCs identical to each other or CCs different from each other. Hence, according to an example shown in Table 2, since a transmission direction of the CC1 and a transmission direction of the CC2 are different from each other in a subframe #4 and a subframe #9, the subframes may become conflict subframes. In this case, a half-duplex UE (HD UE) can receive a UL grant (PDCCH) used for transmitting UL data on the CC1 in an SF #0. In this case, according to an example shown in Table 5, the half-duplex UE can perform UL data transmission in the SF #4. Hence, a transmission direction of a conflict subframe can be determined as UL to transmit the UL data in the conflict subframe #4. Hence, the CC1 is operated and the CC2 is not operated in the conflict subframe #4. On the contrary, the UL data transmission may not be performed in the conflict subframe #9. If it is assumed that a transmission direction of a conflict subframe in which UL data transmission is not performed follows a specific CC (e.g., PCC or PCell), the transmission direction can be determined as DL in the conflict subframe #9 according to the specific CC (e.g., PCC or PCell). The transmission direction of the conflict subframe in which the UL data transmission is not performed can be determined by a different method instead of the PCC.

Referring to FIG. 18, a user equipment configures a PCC, a CC1 and a CC2 to be carrier-aggregated by a TDD scheme. The PCC and the CC1 are configured by a UL-DL configuration #0 and the CC2 is configured by a UL-DL configuration #1. Hence, according to an example shown in Table 2, since a transmission direction of the CC1 and a transmission direction of the CC2 are different from each other in a subframe #4, a subframe #9, a subframe #14 and a subframe #19, the subframes may become conflict subframes. In this case, a half-duplex UE (HD UE) can transmit UL data (e.g., PUSCH) in an SF #8. According to an example shown in Table 7, the half-duplex UE can receive ACK/NACK response in response to the UL data in the SF #14. Hence, a transmission direction of a conflict subframe can be determined as DL to receive PHICH in the conflict subframe #14. Hence, the CC1 is not operated and the CC2 is operated in the conflict subframe #14. On the contrary, PHICH may not be received in the conflict subframe SF #4, the SF #9 and the SF #19. If it is assumed that different subframes (e.g., the SF #4, the SF #9 and the SF #19) in which PHICH is not received follow a transmission direction of a specific CC (e.g., PCC or PCell), a transmission direction of a conflict subframe can be determined as UL according to the specific CC (e.g., PCC or PCell). The transmission direction of the conflict subframe in which PHICH is not received can be determined by a different method instead of the PCC. The example shown in FIG. 17 is just an example. If CCs having UL-DL configuration different from the UL-DL configuration shown in FIG. 17 are aggregated with each other, an identical principle can also be applied.

Meanwhile, in LTE-A system, two types of transmission scheme can be used to transmit a sounding reference signal (SRS) for the purpose of estimating an UL channel. For instance, the transmission scheme of the SRS includes a periodic SRS transmission scheme and an aperiodic SRS transmission scheme. For clarity, the periodic SRS transmission scheme is called a p-SRS scheme and the aperiodic SRS transmission scheme is called an a-SRS scheme in the following description. In case of the p-SRS scheme, a subframe (hereinafter “p-SRS SF”) in which an SRS is periodically transmitted and relevant parameters such as a transmission bandwidth and the like are configured via RRC. An SRS can be periodically transmitted in every subframe (p-SRS SF) which is configured with a prescribed period without a separate command or indication triggering SRS transmission. On the contrary, in case of the a-SRS scheme, a subframe (hereinafter “a-SRS SF”) capable of transmitting an SRS and relevant parameters such as a transmission bandwidth and the like are configured via upper layer (e.g., RRC layer). If an SRS transmission triggering indication is received via DL/UL grant PDCCH and the like, an SRS can be transmitted via a nearest a-SRS SF after timing on which the SRS transmission triggering indication is received(or timing after a prescribed subframe from the timing on which the SRS transmission triggering indication is received).

In this case, if a HD-UE considers a conflict subframe configuration in CA between CCs having UL-DL configurations different from each other, a transmission direction in a conflict subframe is dependently determined based on a UL-DL configuration of a specific CC or scheduling of a base station (e.g., eNB). In doing so, the transmission direction in the conflict subframe may be frequently determined as DL according to a situation, this may cause UL resource shortage and may consequently bring about a result of losing lots of chances to transmit an SRS (i.e., frequent case of giving up SRS transmission). In a different point of view, in order for a base station (e.g., eNB) to secure SRS transmission, the base station may configure a subframe in which an SRS is transmitted by an UL subframe instead of a conflict subframe. Or, in order to secure SRS transmission, a base station (e.g., eNB) may appropriately or limitedly schedule a subframe in which an SRS is transmitted not to be configured as DL (e.g., PHICH timing).

Meanwhile, in case of TDD system, it may be required to have a transmission/reception timing gap including a transmission/reception switching gap to switch a transmission/reception operation from a DL subframe to an UL subframe. To this end, a special subframe can be managed between the DL subframe and the UL subframe. In particular, as shown in an example of Table 2, various special subframe configurations can be supported according to a radio condition, cell coverage and the like.

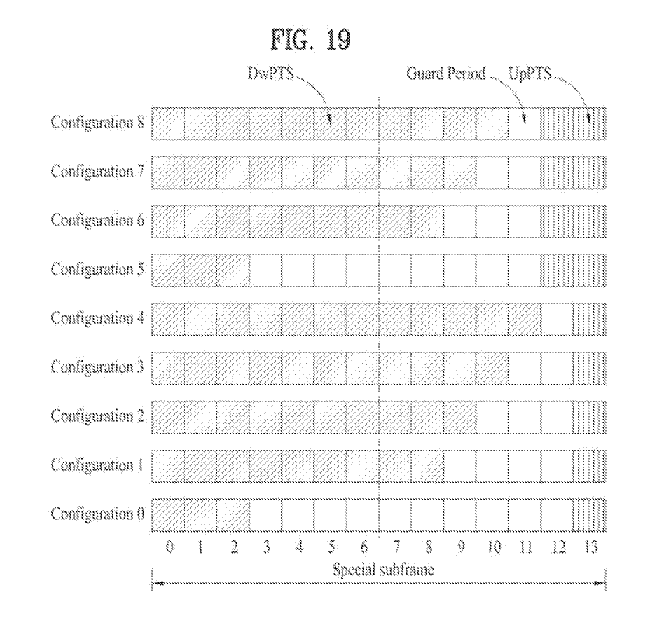

FIG. 19 is a diagram for an example of the number of symbols of a special subframe. In a special subframe, the number of symbols (e.g., OFDM) in a DL period (e.g., DwPTS), the number of symbols in a guard period (e.g., GP) and the number of symbols in an UL period (e.g., UpPTS) may vary according to a special subframe configuration shown in an example of Table 2. For clarity, a case of using a normal CP (i.e., 14 symbols per subframe) is explained. Yet, a size of a DL period (e.g., DwPTS) and a size of an UL period (e.g., UpPTS), which are capable of being configured in a special subframe, may vary according to a CP combination (normal CP or extended CP) used for DL/UL. For instance, a DL period (e.g., DwPTS) can consist of 3 to 12 OFDM symbols according to a special subframe configuration in a special subframe. Hence, PHICH/PDCCH transmission is permitted only or both PHICH/PDCCH transmission and PDSCH transmission are permitted in a DL period (e.g., DwPTS) in a special subframe according to the number of symbols. And, an UL period (e.g., UpPTS) of a special subframe can consist of 1 to 2 SC-FDM symbols. Hence, an SRS and/or a random access preamble of a short length can be transmitted via an UL period (e.g., UpPTS) of a special subframe.

Hence, when carrier aggregation is performed between a plurality of CCs, the present invention proposes a method for a half-duplex UE (HD-UE) to perform DL reception and UL transmission together using a TDM (time division multiplexing) scheme in a conflict subframe in a manner of being similar to the aforementioned special subframe structure. In more particular, when carrier aggregation is performed between a plurality of CCs, the present invention proposes a method for a half-duplex UE (HD-UE) to perform DL reception and UL transmission together using a TDM (time division multiplexing) scheme in a conflict subframe configured as a subframe capable of transmitting an SRS. For instance, the subframe capable of transmitting an SRS can include p-SRS SF and/or a-SRS SF. According to the present method, when a first CC and a second CC are aggregated, a UE operating in a half-duplex scheme receives a DL signal on the first CC during a first symbol period of a conflict subframe and can transmit an UL signal on the second CC during a second symbol period of the conflict subframe. And, the first CC can be configured as a DL subframe in the conflict subframe and the second CC can be configured as an UL subframe in the conflict subframe. For instance, in case of TDD system, the first CC and the second CC may have a UL-DL configuration different from each other. In the present specification, a symbol period and a symbol can be used in a manner of being mixed. And, a symbol used for receiving a DL signal may correspond to an OFDM (orthogonal frequency division multiple access) symbol and a symbol used for transmitting an UL signal may correspond to an SC-FDM (single carrier frequency division multiple access) symbol.

The present invention can be applied irrespective of whether a conflict subframe corresponds to a subframe capable of transmitting an SRS. For instance, when a first CC and a second CC are aggregated, a UE operating in a half-duplex scheme receives a DL signal on the first CC during a first symbol period of the conflict subframe and can transmit an UL signal on the second CC during a second symbol period of the conflict subframe irrespective of transmission of an SRS. Or, on the contrary, the UE can transmit an UL signal on the second CC during the first symbol period of the conflict subframe and can receive a DL signal on the first CC during the second symbol period of the conflict subframe.

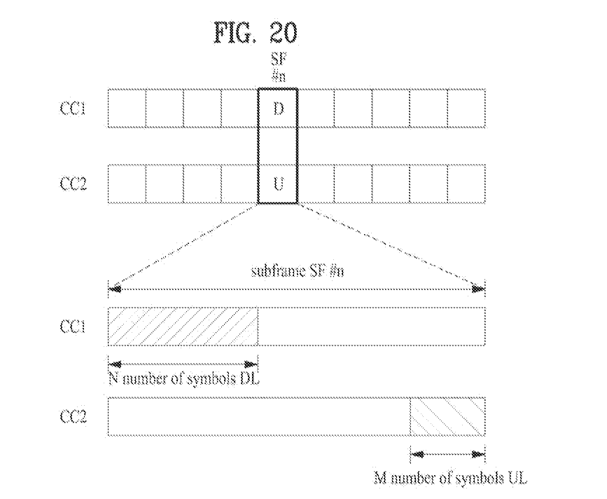

FIG. 20 is a diagram for an example of a method of transceiving a signal in a conflict subframe according to the present invention. Referring to FIG. 20, since a CC1 is configured as DL and a CC2 is configured as UL in a subframe #n, the subframe #n may correspond to a conflict subframe.

Referring to FIG. 20, a half-duplex UE can be configured to perform DL reception on a CC (e.g., CC1) configured as DL during a first N number of symbol (e.g., OFDM symbol) period in a conflict subframe configured as a subframe (e.g., p-SRS SF and/or a-SRS SF) capable of transmitting an SRS. For instance, the half-duplex UE can receive a PCFICH, a PHICH, a PDCCH, a PDSCH, an E-PDCCH, a CRS, a DMRS, a CSI-RS and a combination thereof on the CC1 for the first N number of symbols of the subframe #n. And, the half-duplex UE can be configured to perform UL transmission (e.g., SRS transmission) on a CC (e.g., CC2) configured as UL for the last M number of symbols (e.g., SC-FDM symbol) of the subframe #n. As an example, if the N is set to be equal to or less than 3, the half-duplex UE can receive the PCFICH, the PHICH, the PDCCH (e.g., UL grant) and the combination thereof during the N number of symbol periods without transmitting the PDSCH/E-PDCCH. As a different example, the N can be set to be equal to or greater than 3 and equal to or less than 12. As a further different example, if the M is set to be equal to or greater than 2, a random access preamble (RAP) of a short length can be additionally permitted to be transmitted as well as SRS transmission for the M number of symbol periods. As a further different example, the M can be set to be equal to or greater than 1 and equal to or less than 2.

Or, unlike an example shown in FIG. 20, UL transmission can be performed on a CC (e.g., CC2) configured as UL during the first N number of symbol periods and DL reception can be performed on a CC (e.g., CC1) configured as DL during the last M number of symbol periods.

Or, as shown in the example of FIG. 20, PHICH and/or UL grant (e.g., PDCCH) reception can be set to be performed on a CC configured as DL only in a conflict subframe configured as a subframe capable of transmitting an SRS and SRS transmission can be set to be performed on a CC configured as UL only without a separate configuration for a DL/UL transmission/reception period in the conflict subframe.

Or, it is not necessary to configure an SRS to be unconditionally transmitted in all conflict subframes. Instead, it is able to configure an SRS to be flexibly transmitted in a part of conflict subframes only. Hence, an UL/DL TDM operation between CCs different from each other can be applied to all conflict subframes configured as a subframe capable of transmitting an SRS or a part of conflict subframes designated as the subframe capable of transmitting the SRS.

The method according to the present invention can be limitedly applied to a conflict subframe configured as a-SRS SF only. Or, the method according to the present invention can be limitedly applied to a case that indication information triggering transmission of a-SRS is received in a conflict subframe configured as the a-SRS SF. In case that a base station triggers transmission of a-SRS, it may correspond to a case that SRS reception is mandatory. Hence, the method according to the preset invention can be more profitably applied in case that the indication information triggering transmission of the a-SRS is received in the conflict subframe configured as the a-SRS SF.

Or, the method according to the present invention can be limitedly applied to a case that a conflict subframe configured as a subframe (e.g., p-SRS SF and/or a-SRS SF) capable of transmitting an SRS is set by PHICH reception timing for UL data transmission. If a half-duplex UE operates as UL to transmit an SRS and is unable to receive PHICH, a base station should retransmit PHICH, thereby reducing efficiency. Hence, if a conflict subframe configured as a subframe (e.g., p-SRS SF and/or a-SRS SF) capable of transmitting an SRS is set by PHICH reception timing for UL data transmission, a half-duplex UE can perform SRS transmission and PHICH reception at the same time.

Or, the method according to the present invention can be limitedly applied to a case that a conflict subframe is configured as a-SRS SF and is set to receive PHICH at the same time. As a specific example, if a conflict subframe configured as a-SRS SF is set by PHICH reception timing and a-SRS is triggered to be transmitted via the conflict subframe at the same time, PHICH and/or UL grant PDCCH reception can be configured to be performed on a CC configured as DL only and a-SRS transmission can be configured to be performed on a CC configured as UL only via the conflict subframe.

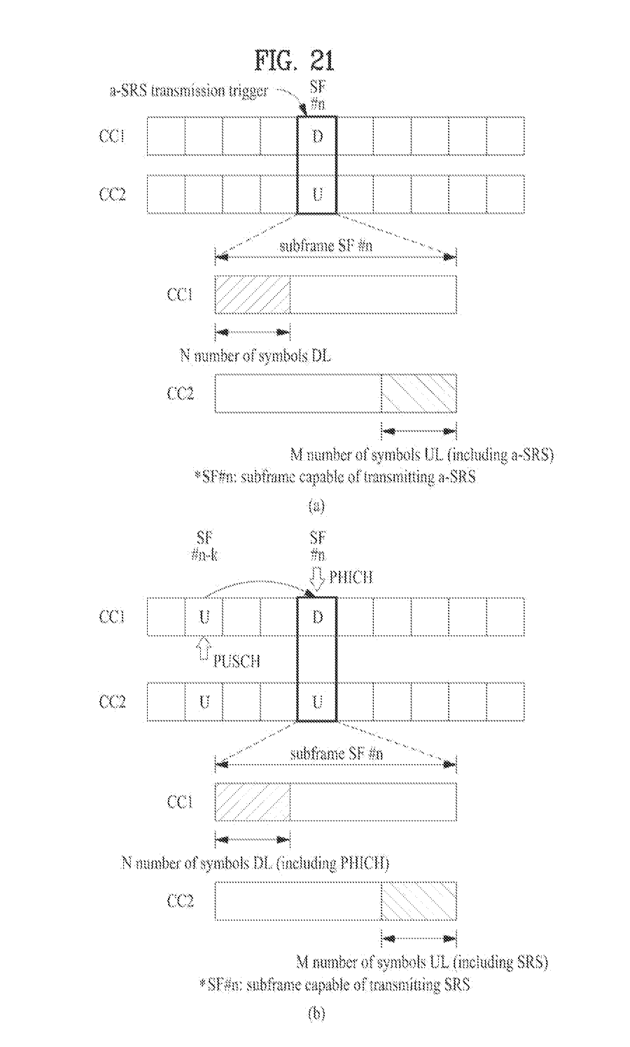

FIG. 21 is a diagram for an example of a method of transceiving a signal in a conflict subframe configured as a subframe capable of transmitting an SRS according to the present invention. In FIG. 21, a subframe #n corresponds to a subframe capable of transmitting an SRS. Since a transmission direction of a CC1 and a transmission direction of a CC2 are set to DL and UL, respectively, the subframe #n corresponds to a conflict subframe.

Referring to FIG. 21 (a), a conflict subframe SF #n may correspond to a subframe capable of transmitting a-SRS. In this case, a half-duplex UE receives a DL signal on a CC1 configured as DL during the N number of symbol periods and may be able to transmit an UL signal on a CC2 configured as UL during M number of symbol periods irrespective of whether information triggering transmission of the a-SRS is received in the conflict subframe SF #n. In this case, if the half-duplex UE does not receive the information triggering transmission of the a-SRS in the conflict subframe SF #n, the half-duplex UE does not transit the a-SRS in the conflict subframe SF #n.

Or, as shown in an example of FIG. 21 (a), if the half-duplex UE receives the information triggering transmission of the a-SRS in the conflict subframe SF #n, the half-duplex UE can perform UL transmission on the CC2 to transmit the a-SRS. If the half-duplex UE does not receive the information triggering transmission of the a-SRS in the conflict subframe SF #n, the half-duplex UE does not perform UL transmission on the CC2 and may be able to continuously perform DL reception on the CC1.

Referring to FIG. 21 (b), a conflict subframe SF #n may correspond to a subframe (e.g., a-SRS SF and/or p-SRS SF) capable of transmitting an SRS. The conflict subframe SF #n can be configured to receive a response signal (e.g., ACK/NACK or PHICH) in response to an UL signal transmitted in an SF # n−k. For instance, the conflict subframe SF #n can be configured by PHICH reception timing. In this case, a half-duplex UE receives a DL signal as well as the response signal (e.g., ACK/NACK or PHICH) in response to the UL signal on the CC 1 during the first N number of symbol periods and may be able to transmit an UL signal as well as an SRS on the CC2 during the last M number of symbol periods.

In the example of FIG. 21, the method according to the present invention can be limitedly applied to a case that a conflict subframe is configured as a-SRS SF and is configured to receive PHICH at the same time.

The method according to the present invention can be identically applied to a case that a conflict subframe consists of a DL subframe and a special subframe. For instance, the method according to the present invention can be applied in a manner that an UL period (e.g., UpPTS) in a special subframe is considered as an UL subframe. In this case, a half-duplex UE performs DL reception on a CC configured as DL during a part of symbol periods of a DL subframe, performs DL reception on a CC configured as S during all or a part of symbol periods of a DL period (e.g., DwPTS) of a special subframe and may be able to perform UL transmission on the CC configured as S during all or a part of symbol periods of an UL period (e.g., UpPTS) of a conflict subframe.

Or, the method according to the present invention can be applied to a case that a conflict subframe consists of a DL subframe and a special subframe and an UL period (e.g., UpPTS) of the conflict subframe is configured as a subframe capable of transmitting a random access preamble (RAP) (of short length). In this case, a half-duplex UE performs DL reception on a CC configured as DL during a part of symbol periods of the DL subframe, performs DL reception on a CC configured as S during all or a part of symbol periods of a DL period (e.g., DwPTS) of the special subframe and may be able to perform UL transmission including transmission of the random access preamble (RAP) (of short length) on the CC configured as S during all or a part of symbol periods of an UL period (e.g., DwPTS) of the conflict subframe.

Or, the method according to the present invention can be applied only when a conflict subframe consists of a DL subframe and a special subframe, the conflict subframe is configured as a subframe capable of transmitting a RAP and information triggering transmission of the RAP is received (e.g., a PDCCH order indicating transmission of the RAP is received from a base station (e.g., eNB) in the conflict subframe) in the conflict subframe. In this case, a half-duplex UE performs DL reception on a CC configured as DL during a part of symbol periods of the DL subframe, performs DL reception on a CC configured as S during all or a part of symbol periods of a DL period (e.g., DwPTS) of the special subframe and may be able to perform UL transmission on the CC configured as S only when the information triggering transmission of the RAP is received. If the information triggering transmission of the RAP is not received, the half-duplex UE does not perform UL transmission on the CC configured as S and may be able to continuously perform DL reception on the CC configured as DL in the conflict subframe.

Or, the method according to the present invention can be identically applied to a case that a conflict subframe consists of a special subframe and an UL subframe. For instance, the method according to the present invention can be applied in a manner that a DL period (e.g., DwPTS) in the special subframe is considered as a DL subframe. In this case, a half-duplex UE performs DL reception on a CC configured as S during all or a part of symbol periods of the DL period (e.g., DwPTS) of the special subframe, performs UL transmission on a CC configured as UL during a part of symbol periods of the UL subframe and can perform UL transmission on a CC configured as S during all or a part of symbol periods of an UL period (e.g., UpPTS) of the special subframe.

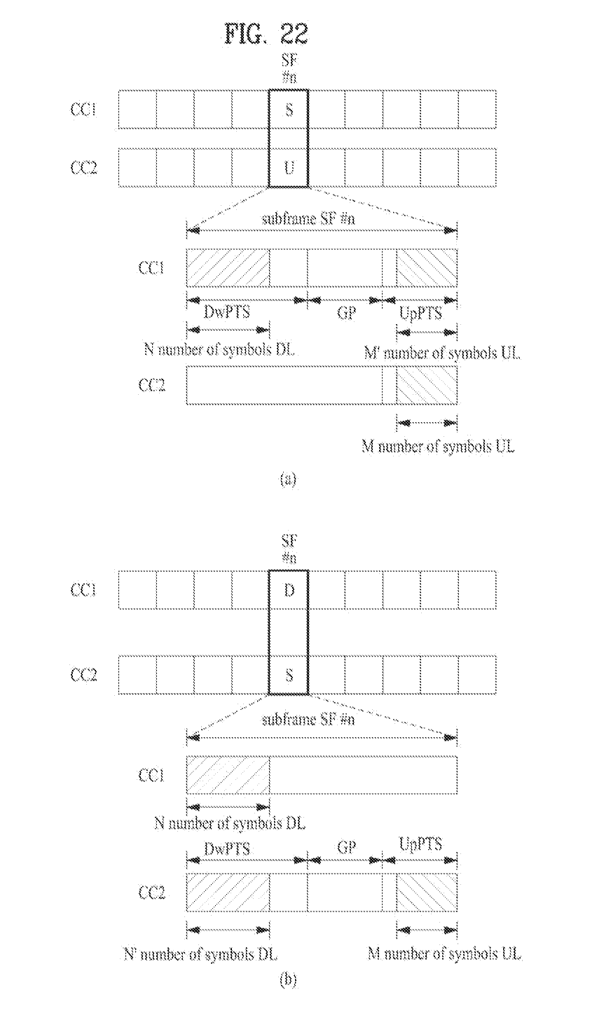

FIG. 22 is a diagram for an example of a method of transceiving a signal in case that a conflict subframe consists of a special subframe and a DL or an UL subframe. Referring to FIG. 22, since a transmission direction of a part of a CC1 and a transmission direction of a part of a CC2 are set to UL and DL, respectively, in a subframe SF #n, the subframe SF #n may correspond to a conflict subframe.

Referring to FIG. 22 (a), a half-duplex UE can perform DL reception on the CC1 during the first N number of symbol periods in the conflict subframe SF #n. The N number of symbol periods may be matched with a DL period (e.g., DwPTS) of a special subframe or may be different from the DL period of the special subframe. For instance, although FIG. 22 (a) shows an example of the N number of symbol periods smaller than the DL period (e.g., DwPTS) of the special subframe, the N number of symbol periods may be identical to the DL period (e.g., DwPTS) of the special subframe or may be greater than the DL period (e.g., DwPTS) of the special subframe.

Referring to FIG. 22 (a), the half-duplex UE performs UL transmission on a CC1 during the last M′ number of symbol periods and may be able to perform UL transmission on a CC2 during the last M number of symbol periods. In this case, the M′ and the M may be identical to each other or may be different from each other. And, the M′ number of symbol periods may be matched with an UL period (e.g., UpPTS) of a special subframe or may be different from the UL period of the special subframe. Similarly, the M number of symbol periods may be matched with the UL period (e.g., UpPTS) of the special subframe or may be different from the UL period of the special subframe. For instance, although FIG. 22 (a) shows an example of the M′ number of symbol periods (or the M number of symbol periods) smaller than the UL period (e.g., UpPTS) of the special subframe, the M′ number of symbol periods (or the M number of symbol periods) may be identical to the UL period (e.g., UpPTS) of the special subframe or may be greater than the UL period (e.g., UpPTS) of the special subframe.

Referring to FIG. 22 (b), a half-duplex UE performs DL reception on a CC1 during the first N number of symbol periods and may be able to perform DL reception on a CC2 during the first N′ number of symbol periods. In this case, the N and the N′ may be identical to each other or may be different from each other. And, the N number of symbol periods may be matched with a DL period (e.g., DwPTS) of a special subframe or may be different from the DL period of the special subframe. Similarly, the N′ number of symbol periods may be matched with the DL period (e.g., DwPTS) of the special subframe or may be different from the DL period of the special subframe. For instance, although FIG. 22 (b) shows an example of the N number of symbol periods (or the N′ number of symbol periods) smaller than the DL period (e.g., DwPTS) of the special subframe, the N number of symbol periods (or the N′ number of symbol periods) may be identical to the DL period (e.g., DwPTS) of the special subframe or may be greater than the DL period (e.g., DwPTS) of the special subframe.

Referring to FIG. 22 (b), the half-duplex UE can perform UL transmission on the CC2 during the last M number of symbol periods in the conflict subframe SF #n. The M number of symbol periods may be matched with an UL period (e.g., UpPTS) of a special subframe or may be different from the UL period of the special subframe. For instance, although FIG. 22 (b) shows an example of the M number of symbol periods smaller than the UL period (e.g., UpPTS) of the special subframe, the M number of symbol periods may be identical to the UL period (e.g., UpPTS) of the special subframe or may be greater than the UL period (e.g., UpPTS) of the special subframe.

The method according to the present invention is not limitedly applied to a situation of carrier aggregation (CA) between CCs having UL-DL configurations different from each other in TDD system. The method according to the present invention can be applied to such a situation as operating in a half-duplex (HD) scheme. As an example, the method according to the present invention can also be applied to a half-duplex UE (HD-UE) operating in FDD system where a single cell consists of a DL carrier and an UL carrier. For instance, since the DL carrier and the UL carrier are independently exist in the FDD system, a conflict subframe may occur in every subframe. In this case, the HD-UE may perform UL transmission or DL transmission in every conflict subframe. Or, similar to the CA between the CCs having TDD UL-DL configurations different from each other, the method according to the present invention can be applied in a manner of considering a DL carrier and an UL carrier in a specific conflict subframe as a DL subframe and an UL subframe, respectively. For instance, the HD-UE can perform DL reception on the DL carrier during the first N number of symbol periods of the specific conflict subframe and can perform UL transmission on the UL carrier during the last M number of symbol periods of the specific conflict subframe. Or, the HD-UE can perform UL transmission on the UL carrier during the first N number of symbol periods of the specific conflict subframe and can perform DL reception on the DL carrier during the last M number of symbol periods of the specific conflict subframe.

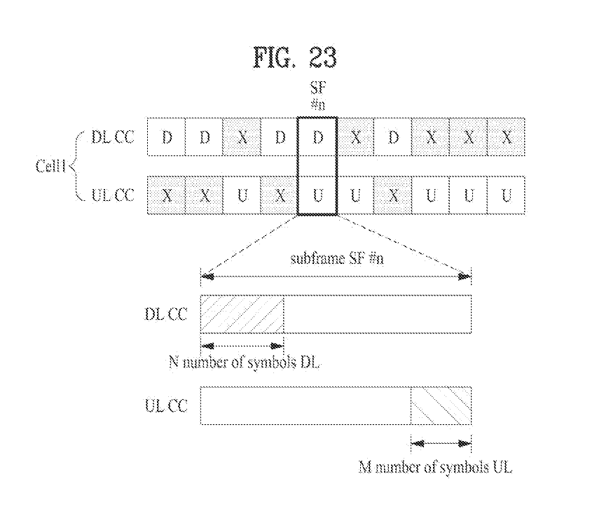

FIG. 23 is a diagram for an example of a method of transceiving a signal in a FDD system according to the present invention. As shown in an example of FIG. 23, a half-duplex UE can perform either a DL reception operation or an UL transmission operation in every subframe except a specific subframe SF #n. And, the half-duplex UE can perform DL reception and UL transmission in the specific subframe SF #n with a TDM scheme according to the present invention.

Referring to FIG. 23, the half-duplex UE performs DL reception on a DL carrier (CC) during the first N number of symbol periods and can perform UL transmission on an UL carrier (CC) during the last M number of symbol periods in the subframe SF #n. Or, unlike what is shown in the drawing, the half-duplex UE performs UL transmission on the UL carrier (CC) during the first N number of symbol periods and can perform DL reception on the DL carrier (CC) during the last M number of symbol periods in the subframe SF #n.

Meanwhile, according to advanced LTE system, a specific UL subframe (or a special subframe) configured in advance in a single TDD cell/carrier via a system information block (SIB) can be reconfigured as a DL subframe for traffic adaptation and the like. If information indicating reconfiguration of a specific subframe from an UL subframe (or a special subframe) to a DL subframe is received, an advanced UE can manage the specific subframe as a DL subframe. Hence, the method according to the present invention can also be applied when the aforementioned subframe reconfiguration is applied. The information indicating the reconfiguration can be semi-statically or dynamically received via L1 signaling (e.g., signaling on PDCCH), L2 signaling (e.g., signaling via an MAC message), upper layer signaling (e.g., RRC signaling) or the like. For instance, subframe reconfiguration in TDD system can be performed by reconfiguring an UL-DL configuration.

For instance, having received the information indicating the subframe reconfiguration, the advanced UE may use a specific subframe (e.g., UL subframe or special (S) subframe) by reconfiguring the specific subframe as a DL subframe. Hence, it may assume/consider that a conflict subframe is configured between the specific subframe (e.g., UL subframe or special (S) subframe) before the reconfiguration and the DL subframe after the reconfiguration. According to the method of the present invention, the advanced UE can perform DL reception during the first N number of symbol periods of the specific subframe and can perform UL transmission during the last M number of symbol periods of the specific subframe.

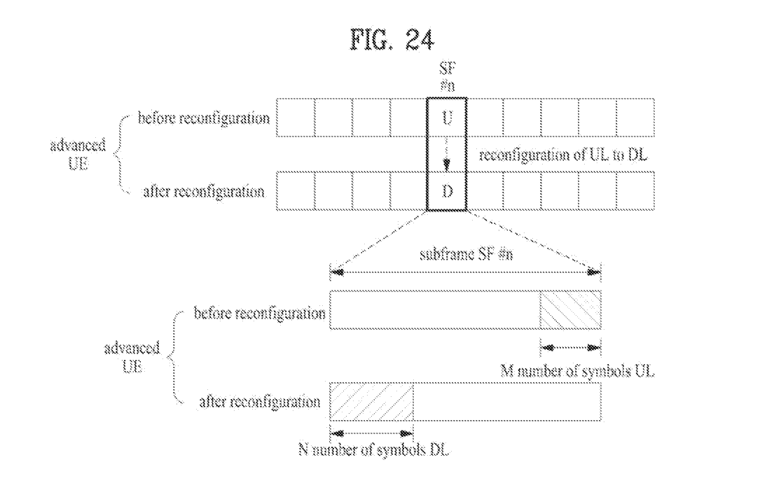

FIG. 24 is a diagram for an example of a method of transceiving a signal according to the present invention in case that a specific subframe is reconfigured and used as a DL subframe. A base station can transmit information indicating reconfiguration of a subframe SF #n from an UL subframe (or special subframe) to a DL subframe to user equipments via L1 signaling (e.g., signaling on PDCCH), L2 signaling (e.g., signaling via an MAC message), upper layer signaling (e.g., RRC signaling) or the like in a cell.

Referring to FIG. 24, an advanced UE performs DL reception during the first N number of symbol periods and can perform UL transmission during the last M number of symbol periods in the subframe SF #n. Or, unlike the example shown in the drawing, the advanced UE performs UL transmission during the first N number of symbol periods and can perform DL reception during the last M number of symbol periods.

Although FIG. 24 shows an example that a specific subframe SF #n corresponds to an UL subframe, an identical principle can also be applied when the specific subframe SF #n corresponds to a special subframe. If the specific subframe SF #n corresponds to the special subframe, explanation mentioned earlier with reference to FIG. 22 (b) can be applied. Compared to FIG. 22 (b), since a single CC (or cell) is assumed instead of a CC1 and a CC2 in FIG. 24, the CC2 corresponds to a special subframe before the reconfiguration and the CC1 corresponds to a special subframe after the reconfiguration. Under this assumption, the explanation mentioned earlier with reference to FIG. 22 (b) can be invoked (incorporate by reference).

In the foregoing description, various embodiments are explained in relation to the method according to the present invention. Each of the embodiments can be implemented in a manner of excluding an element from an embodiment or additionally adding a different element to an embodiment. Moreover, each of the embodiments can be independently applied or can be implemented in a manner of being combined with each other.

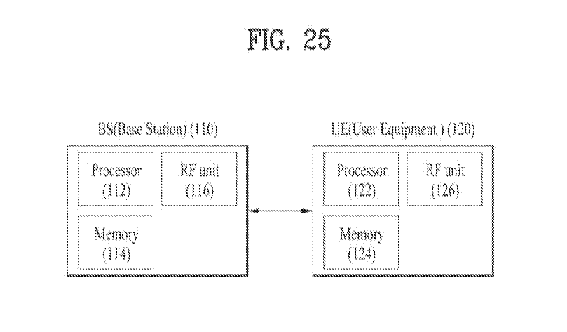

FIG. 25 is a diagram for a base station and a user equipment applicable to the present invention.

Referring to FIG. 25, a wireless communication system includes a base station (BS) 110 and a user equipment (UE) 120. If the wireless communication system includes a relay, the BS or the UE can be replaced with the relay.

The base station 110 includes a processor 112, a memory 114, and a RF (radio frequency) unit 116. The processor 112 is configured to implement a proposed function, a procedure and/or a method. The memory 114 is connected with the processor 112 and stores various informations associated with operations of the processor 112. The RF unit 116 is connected with the processor 112 and is configured to transmit/receive a radio signal. The user equipment 120 includes a processor 122, a memory 124, and a RF (radio frequency) unit 126. The processor 122 is configured to implement a proposed function, a procedure and/or a method. The memory 124 is connected with the processor 122 and stores various informations associated with operations of the processor 122. The RF unit 126 is connected with the processor 122 and is configured to transmit/receive a radio signal.

The above-mentioned embodiments correspond to combinations of elements and features of the present invention in prescribed forms. And, it is able to consider that the respective elements or features are selective unless they are explicitly mentioned. Each of the elements or features can be implemented in a form failing to be combined with other elements or features. Moreover, it is able to implement an embodiment of the present invention by combining elements and/or features together in part. A sequence of operations explained for each embodiment of the present invention can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

In this disclosure, a specific operation explained as performed by a base station may be performed by an upper node of the base station in some cases. In particular, in a network constructed with a plurality of network nodes including a base station, it is apparent that various operations performed for communication with a terminal can be performed by a base station or other networks except the base station. Moreover, in this document, ‘base station (BS)’ may be substituted with such a terminology as a fixed station, a Node B, an eNode B (eNB), an access point (AP) and the like. And, ‘terminal’ may be substituted with such a terminology as a user equipment (UE), a mobile station (MS), a mobile subscriber station (MSS) and the like.

Embodiments of the present invention can be implemented using various means. For instance, embodiments of the present invention can be implemented using hardware, firmware, software and/or any combinations thereof. In case of the implementation by hardware, a method according to each embodiment of the present invention can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code is stored in a memory unit and is then drivable by a processor. The memory unit is provided within or outside the processor to exchange data with the processor through the means well-known to the public.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents. And, it is apparently understandable that an embodiment is configured by combining claims failing to have relation of explicit citation in the appended claims together or can be included as new claims by amendment after filing an application.

### INDUSTRIAL APPLICABILITY

The present invention can be used by such a wireless communication device as a user equipment, a base station and the like.

What is claimed is:

1. A method of transceiving a signal in a specific subframe by a user equipment operating in a half-duplex scheme in a wireless communication system in which a first carrier and a second carrier are aggregated, the method comprising:
receiving a downlink signal on the first carrier during a first symbol period of the specific subframe; and
transmitting an uplink signal on the second carrier during a second symbol period of the specific subframe,
wherein the specific subframe is configured as a downlink subframe on the first carrier and the specific subframe is configured as an uplink subframe on the second carrier, and
wherein the specific subframe corresponds to a subframe configured to transmit an uplink reference signal.

2. The method of claim 1, wherein the specific subframe further corresponds to a subframe configured to receive an ACK/NACK (acknowledgement/negative-acknowledgement) signal in response to uplink data transmission.

3. The method of claim 1, further comprising receiving information indicating that an aperiodic sounding reference signal is to be transmitted in the specific subframe, wherein the uplink reference signal includes the aperiodic sounding reference signal.

4. The method of claim 1, further comprising receiving information indicating that a random access preamble signal is to be transmitted in the specific subframe, wherein the uplink signal includes the random access preamble signal.

5. The method of claim 1, wherein the specific subframe comprises a downlink period, a guard period and an uplink period on the first carrier, and wherein the first symbol period includes at least a part of the downlink period.

6. The method of claim 1, wherein the specific subframe comprises a downlink period, a guard period and an uplink period on the second carrier, and wherein the second symbol period includes at least a part of the uplink period.

7. The method of claim 1, when the user equipment satisfies a certain condition, the method further comprising:
receiving information indicating that the specific subframe is to be reconfigured from an uplink subframe to a downlink subframe on the second carrier; and
receiving the downlink signal on the second carrier during the first symbol period of the specific subframe.

8. The method of claim 1, wherein the first symbol period comprises 3 to 12 symbols, and wherein the second symbol period comprises 1 to 2 symbols.

9. A user equipment configured to transceive a signal in a specific subframe using a half-duplex scheme in a wireless communication system in which a first carrier and a second carrier are aggregated, the user equipment comprising:
an RF (radio frequency) unit; and
a processor, the processor configured to:
receive a downlink signal on the first carrier during a first symbol period of the specific subframe, and
transmit an uplink signal on the second carrier during a second symbol period of the specific subframe,
wherein the specific subframe is configured as a downlink subframe on the first carrier and the specific subframe is configured as an uplink subframe on the second carrier, and
wherein the specific subframe corresponds to a subframe configured to transmit an uplink reference signal.

10. The user equipment of claim 9, wherein the specific subframe further corresponds to a subframe configured to receive an ACK/NACK (acknowledgement/negative-acknowledgement) signal in response to uplink data transmission.

11. The user equipment of claim 9, wherein the processor is further configured to receive information indicating that an aperiodic sounding reference signal is to be transmitted in the specific subframe, and wherein the uplink reference signal includes the aperiodic sounding reference signal.

12. The user equipment of claim 9, wherein the processor is further configured to receive information indicating that a random access preamble signal is to be transmitted in the specific subframe, and wherein the uplink signal includes the random access preamble signal.

13. The user equipment of claim 9, wherein the specific subframe comprises a downlink period, a guard period and an uplink period on the first carrier, and wherein the first symbol period includes at least a part of the downlink period.

14. The user equipment of claim 9, wherein the specific subframe comprises a downlink period, a guard period and an uplink period on the second carrier, and wherein the second symbol period includes at least a part of the uplink period.

15. The user equipment of claim 9, wherein when the user equipment satisfies a certain condition, the processor is further configured to:
receive information indicating that the specific subframe is to be reconfigured from an uplink subframe to a downlink subframe on the second carrier, and
receive the downlink signal on the second carrier during the first symbol period of the specific subframe.
